(19) United States
(12) Patent Application Publication
(10) Pub. No.: US 2026/0222218 A1
(43) Pub. Date: Jul. 30, 2026

(54) SYSTEMS AND METHODS TO AUTHENTICATE AND VERIFY AUTHENTICITY OF DIGITAL IMAGES

(71) Applicant: XenTag Corporation, Mississauga (CA)

(72) Inventors: Puneet Pal Singh Randhawa, Mississauga (CA); Vishal Kumar Singh, Mississauga (CA)

(21) Appl. No.: 19/460,587

(22) Filed: Jan. 27, 2026

Related U.S. Application Data
(60) Provisional application No. 63/749,836, filed on Jan. 27, 2025.

(51) Int. Cl. H04L 9/32; G06F 9/4401; H04L 9/08; H04L 9/30

(52) U.S. Cl. CPC H04L 9/3236; G06F 9/4401; H04L 9/0861; H04L 9/30

(57) ABSTRACT

Various systems and methods for generating an authenticatable image by a camera device having an identification tag affixed thereto are disclosed herein. Embodiments disclosed involve operating a camera device to capture an image and operating a processor to retrieve a verifier public key from the identification tag and generating a plurality of encryption keys with at least one of the plurality of encryption keys being generated using the verifier public key. The processor then generates a plurality of authentication image headers, encrypts at least one of the authentication image headers using the encryption keys, and couples the plurality of authentication image headers to the image. Various systems and methods for verifying the authenticity of an image are also disclosed.

### CROSS-REFERENCE TO RELATED APPLICATION(S)

This application claims the benefit of U.S. Provisional Patent Application No. 63/749,836 filed Jan. 27, 2025 entitled “SYSTEMS AND METHODS TO AUTHENTICATE AND VERIFY AUTHENTICITY OF DIGITAL IMAGES”. The content of U.S. Provisional Patent Application No. 63/749,836 is hereby incorporated herein by reference in its entirety.

### FIELD

The embodiments described herein generally relate to systems and methods for authenticating and verifying the authenticity of digital images.

### BACKGROUND

The following is not an admission that anything discussed below is part of the prior art or part of the common general knowledge of a person skilled in the art.

With rapid advancements in generative artificial intelligence (AI), fabricated digital content, particularly images and videos, can now appear so realistic that even experts find it challenging to detect forgeries. This ability to create convincing counterfeit media has profound implications for the integrity of visual evidence, impacting critical fields such as law enforcement, journalism, and public trust in media. Historically, creating manipulated images required trained experts and advanced software, but today, nearly anyone with basic AI tools can create convincing digital fabrications. This democratization of image manipulation, combined with the pervasive use of social media and smartphones, has made misinformation and digital forgeries an increasingly common societal threat. Of particular concern are “deepfakes,” AI-generated videos or images that can portray individuals saying or doing things they never did, often in highly realistic ways. Such content can sow distrust, provoke social unrest, and damage reputations, underscoring an urgent need for robust and effective methods to authenticate images and videos at their source, ensuring that visual content remains reliable and trustworthy.

Existing digital image authentication methods, primarily based on cryptographic techniques like public-private key systems, have not kept pace with the sophistication of today's digital fabrication tools. These systems involve a private key embedded within the camera to digitally sign the content, with a corresponding public key available to verify authenticity. However, such approaches are prone to critical vulnerabilities. Cameras without specialized security hardware, like Trusted Platform Modules (TPMs), are often insufficiently protected, making it relatively easy for malicious actors to extract private keys, thus invalidating the security model. If a private key stored on a camera is compromised, it opens the door to forging content on a massive scale, with forgeries indistinguishable from genuine images. Consequently, several manufacturers have abandoned these solutions, as their security relies on a single point of failure. Additionally, consumer devices typically lack secure modules necessary for managing key storage, making them particularly susceptible to tampering. As key management requires careful handling of both the private keys within devices and their distribution among users, there is an added layer of complexity. These limitations of traditional cryptographic systems highlight the urgent need for advancements in image authentication technology that can offer secure, tamper-proof verification suitable for consumer-grade cameras in a way that is both effective and resistant to modern forgery techniques.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least one embodiment, there is provided a method for generating an authenticatable image by a camera device, the camera device having an identification tag affixed thereto. The method comprises: capturing, by the camera device, an image; retrieving, from the identification tag, a verifier public key; generating a plurality of encryption keys, at least one of the plurality of encryption keys being generated using the verifier public key; generating a plurality of authentication image headers; encrypting at least one of the plurality of authentication image headers using at least one encryption key of the plurality of encryption keys; and coupling the plurality of authentication image headers to the image.

In some embodiments, generating the plurality of authentication image headers comprises generating a manufacturing tag header, and generating the manufacturing tag header comprises: generating a local key pair, the local key pair comprising a local private key and a local public key; generating a camera temporary shared key, the camera temporary shared key being based on the local private key and the verifier public key; retrieving, from the identification tag, identification tag data, wherein the identification tag data comprises at least one of: a Universally Unique Identifier (UUID), a tap count, a checksum, a batch ID, a batch creation time, a serial number, and a tag public key; and encrypting the identification tag data using the camera temporary shared key.

In some embodiments, generating the plurality of authentication image headers comprises generating a manufacturing hardware header, and generating the manufacturing hardware header comprises: reading at least one hardware identifier of the camera device from a processing unit of the camera device; and encrypting the at least one hardware identifier using the camera temporary shared key.

In some embodiments, generating the plurality of authentication image headers comprises generating a manufacturing public key header, the manufacturing public key header comprising the local public key.

In some embodiments, generating the plurality of authentication image headers comprises generating a manufacturing weights header, and generating the manufacturing weights header comprises: generating a first layer weights file, the first layer weights file comprising a random list of weights and biases; and encrypting the first layer weights file using the camera temporary shared key.

In some embodiments, generating the plurality of authentication image headers comprises generating a boot key header, and generating the boot key header comprises: upon booting the camera device, generating a boot key pair, the boot key pair comprising a boot private key and a boot public key; and storing the boot public key as the boot key header.

In some embodiments, generating the plurality of authentication image headers comprises generating a boot hardware header, and generating the boot hardware header comprises: generating a camera boot shared key, the camera boot shared key being based on the boot private key and the verifier public key; reading the at least one hardware identifier of the camera device; and encrypting the at least one hardware identifier using the camera boot shared key.

In some embodiments, generating the plurality of authentication image headers comprises generating an operation tag header, and generating the operation tag header comprises: generating a symmetric key, wherein generating the symmetric key comprises: retrieving, from the identification tag data, an encrypted payload field and a checksum field; outputting hex data from a neural network model, wherein the neural network model uses the encrypted payload field as a seed and the checksum field as a prompt; modifying the hex data according to a requirement of the symmetric key; upon booting, retrieving, from the identification tag, the identification tag data; and encrypting the identification tag data using the symmetric key.

In some embodiments, generating the plurality of authentication image headers comprises generating an image hash header, and generating the image hash header comprises: generating an image hash of the image; and encrypting the image hash using the camera boot shared key.

In some embodiments, generating the plurality of authentication image headers comprises generating a watermark header, and generating the watermark header comprises: generating a tuple of x-values using hex values from the hex data; retrieving secret elliptic curve parameters; generating a random point on an elliptic curve defined by the secret elliptic curve parameters; generating a tangent line of the elliptic curve at the random point on the elliptic curve; determining tangent pixels, the tangent pixels comprising the tuple of x-values and corresponding y-values to the tuple of x-values on the tangent line; and encrypting the random point, the tangent pixels and the secret elliptic curve parameters using the camera boot shared key.

In accordance with another aspect, in at least one embodiment, there is provided a system for authenticating a validated image by a camera device, the camera device having an identification tag and a tag reader affixed thereto. The system comprises: a computing device comprising at least one processor operable to: capture an image; retrieve, from the identification tag, a verifier public key; generate a plurality of encryption keys, at least one of the plurality of encryption keys being generated using the verifier public key; generate a plurality of authentication image headers; encrypt at least one of the plurality of authentication image headers using the plurality of encryption keys; and couple the plurality of authentication image headers to the image.

In some embodiments, generating the plurality of authentication image headers comprises operating the at least one processor to generate a manufacturing tag header, and wherein generating the manufacturing tag header comprises operating the at least one processor to: generate a local key pair, the local key pair comprising a local private key and a local public key; generate a camera temporary shared key, the camera temporary shared key being based on the local private key and the verifier public key; retrieve, from the identification tag, identification tag data, wherein the identification tag data comprises at least one of: a Universally Unique Identifier (UUID), a tap count, a checksum, a batch ID, a batch creation time, a serial number, and a tag public key; and encrypt the identification tag data using the camera temporary shared key.

In some embodiments, generating the plurality of authentication image headers comprises operating the at least one processor to generate a manufacturing hardware header, wherein generating the manufacturing hardware header comprises operating the at least one processor to: read at least one hardware identifier of the camera device from a processing unit of the camera device; and encrypt the at least one hardware identifier using the camera temporary shared key.

In some embodiments, generating the plurality of authentication image headers comprises operating the at least one processor to generate a manufacturing public key header, the manufacturing public key header comprising the local public key.

In some embodiments, generating the plurality of authentication image headers comprises generating a manufacturing weights header, and generating the manufacturing weights header comprises operating the at least one processor to: generate a first layer weights file, the first layer weights file comprising a random list of weights and biases; and encrypt the first layer weights file using the camera temporary shared key.

In some embodiments, generating the plurality of authentication image headers comprises operating the at least one processor to generate a boot key header, and generating the boot key header comprises operating the at least one processor to: upon booting the camera device, generate a boot key pair, the boot key pair comprising a boot private key and a boot public key; and store the boot public key as the boot key header.

In some embodiments, generating the plurality of authentication image headers comprises operating the at least one processor to generate a boot hardware header, and generating the boot hardware header comprises operating the at least one processor to: generate a camera boot shared key, the camera boot shared key being based on the boot private key and the verifier public key; read the at least one hardware identifier of the camera device; and encrypt the at least one hardware identifier using the camera boot shared key.

In some embodiments, generating the plurality of authentication image headers comprises operating the at least one processor to generate an operation tag header, and generating the operation tag header comprises operating the at least one processor to: generate a symmetric key, wherein generating the symmetric key comprises operating the at least one processor to: retrieve, from the identification tag data, an encrypted payload field and a checksum field; output a hex data from a neural network model, wherein the neural network model uses the encrypted payload field as a seed and the checksum field as a prompt; modify the hex data according to a requirement of the symmetric key; upon booting, retrieve, from the identification tag, the identification tag data; and encrypting the identification tag data using the symmetric key.

In some embodiments, generating the plurality of authentication image headers comprises operating the at least one processor to generate an image hash header, and generating the image hash header comprises operating the at least one processor to: generate an image hash of the image; and encrypt the image hash using the camera boot shared key.

In some embodiments, generating the plurality of authentication image headers comprises operating the at least one processor to generate a watermark header, and generating the watermark header comprises operating the at least one processor to: generate a tuple of x-values using hex values from the hex data; retrieve secret elliptic curve parameters; generate a random point on an elliptic curve defined by the secret elliptic curve parameters; generate a tangent line of the elliptic curve at the random point on the elliptic curve; determine tangent pixels, the tangent pixels comprising the tuple of x-values and corresponding y-values to the tuple of x-values on the tangent line; and encrypt the random point, the tangent pixels and the secret elliptic curve parameters using the camera boot shared key.

In accordance with another aspect, in at least one embodiment, there is provided a method for verifying an authenticity of an image by a verifier system, the verifier system comprising a processor and a server. The method involves operating the processor to: retrieve, from the server, a verifier private key; receive the image, the image comprising a plurality of authentication image headers and image data; extract a boot public key from a boot key header; generate a verifier boot shared key using the verifier private key and the boot public key; decrypt a first image hash from an image hash header using the verifier boot shared key; generate a second image hash from the image data; and determine the authenticity of the image based on a comparison of the first image hash and the second image hash.

In some embodiments, the method further comprises operating the processor to: extract a local public key from a manufacturing public key header; generate a verifier temporary shared key using the verifier private key and the local public key; decrypt a first identification tag data from a manufacturing tag header using the verifier temporary shared key; retrieve from the server, camera device status information, the camera device status information including information to determine a legitimacy of a camera device; and determine the authenticity of the image based on a comparison of the first identification tag data with the camera device status information.

In some embodiments, the method further comprises operating the processor to: generate a verifier symmetric key, wherein generating the verifier symmetric key comprises operating the processor to: decrypt a first layer weights file from a manufacturing weights header using the verifier temporary shared key, the first layer weights file comprising a random list of weights and biases; retrieve from the server, a verifier weights file; extract an encrypted payload field and a checksum field from the first identification tag data; and generate the verifier symmetric key using the first layer weights file, the verifier weights file, the encrypted payload field and the checksum field; decrypt second identification tag data from an operation tag header using the verifier symmetric key; and determine the authenticity of the image based on a comparison of the first identification tag data and the second identification tag data.

In some embodiments, the method further comprises operating the processor to: operating the processor to: decrypt first hardware identifier data from a manufacturing hardware header using the verifier temporary shared key; decrypt second hardware identifier data from a boot hardware header using the verifier boot shared key; and determine the authenticity of the image based on a comparison of the first hardware identifier data and the second hardware identifier data.

In some embodiments, the method further comprises operating the processor to: decrypt first secret elliptic curve parameters and tangent pixels from a watermark header using the verifier boot shared key; retrieve from the server, second secret elliptic curve parameters; and determine the authenticity of the image based on at least one of a comparison of the first secret elliptic curve parameters and the second secret elliptic curve parameters and a check of the tangent pixels of the image.

In accordance with another aspect, in at least one embodiment, there is provided a verifier system for verifying an authenticity of an image. The verifier system comprises: a server configured to store a verifier private key; a processor operable to: retrieve, from the server, the verifier private key; receive the image, the image comprising a plurality of authentication image headers and image data; extract a boot public key from a boot key header; generate a verifier boot shared key using the verifier private key and the boot public key; decrypt a first image hash from an image hash header using the verifier boot shared key; generate a second image hash from the image data; and determine the authenticity of the image based on a comparison of the first image hash and the second image hash.

In some embodiments, the processor is further operable to: extract a local public key from a manufacturing public key header; generate a verifier temporary shared key using the verifier private key and the local public key; decrypt first identification tag data from a manufacturing tag header using the verifier temporary shared key; retrieve, from the server, camera device status information, the camera device status information including information to determine a legitimacy of a camera device; and determine, the authenticity of the image based on a comparison of the first identification tag data with the camera device status information.

In some embodiments, the processor is further operable to: generate a verifier symmetric key, wherein generating the verifier symmetric key comprises operating the processor to: decrypt, a first layer weights file from a manufacturing weights header using the verifier temporary shared key, the first layer weights file comprising a random list of weights and biases; retrieve, from the server, a verifier weights file; extract, an encrypted payload field and a checksum field from the first identification tag data; and generate the verifier symmetric key using the first layer weights file, the verifier weights file, the encrypted payload field and the checksum field; decrypt second identification tag data from an operation tag header using the verifier symmetric key; and determine the authenticity of the image based on a comparison of the first identification tag data and the second identification tag data.

In some embodiments, the processor is further operable to: decrypt first hardware identifier data from a manufacturing hardware header using the verifier temporary shared key; decrypt second hardware identifier data from a boot hardware header using the verifier boot shared key; and determine the authenticity of the image based on a comparison of the first hardware identifier data and the second hardware identifier data.

In some embodiments, the processor is further operable to: decrypt first secret elliptic curve parameters and tangent pixels from a watermark header using the verifier boot shared key; retrieve, from the server, second secret elliptic curve parameters; and determine the authenticity of the image based on at least one of a comparison of the first secret elliptic curve parameters and the second secret elliptic curve parameters and a check of the tangent pixels of the image.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an example system for authenticating and verifying authenticity of camera images, in communication with external components, in accordance with an embodiment;

FIG. 2 is a block diagram of an example system for authenticating and verifying authenticity of camera images, in communication with external components, in accordance with another embodiment;

FIG. 3 is a block diagram of an example camera system for authenticating images, in accordance with an embodiment;

FIG. 4 is a schematic diagram of an example tag reader, in accordance with an embodiment;

FIG. 5 is a block diagram illustrating an example identification tag communicating with tag readers, in accordance with an embodiment;

FIG. 6 is a schematic diagram of an example identification tag affixed to a camera, in accordance with an embodiment;

FIG. 7 is an example generative neural network for generating authentication data;

FIG. 8 is a schematic diagram of an example image file with authentication image headers, in accordance with an embodiment;

FIG. 9 is a schematic diagram of an example image file with authentication image headers, in accordance with another embodiment;

FIG. 10 is a flowchart of an example method for watermarking an image, in accordance with an embodiment;

FIG. 11 is a plot of an example curve used for watermarking an image;

FIG. 12 is a flowchart of an example method for authenticating an image by a camera device, in accordance with an embodiment;

FIG. 13 is a block diagram of an example system for verifying the authenticity of an image, in accordance with an embodiment; and

FIG. 14 is flowchart of an example method for verifying the authenticity of an image by a verifier system, in accordance with an embodiment.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Unless expressly specified otherwise, the term “image” broadly encompasses various forms of visual media generated, recorded, or displayed by a camera device. This includes, but is not limited to, still photos captured in single or multiple frames, as well as dynamic video sequences composed of a series of frames played in rapid succession. The term “image” further extends to any processed, altered, or digitally synthesized form of visual data and composite images combining multiple inputs. Moreover, the term encompasses raw image data, metadata, and embedded timestamps as well as encoded visual information that may be decoded or reprocessed.

As used herein, the term “camera device” encompasses any digital imaging equipment designed to capture images. This includes traditional digital cameras with fixed or interchangeable lenses, capable of capturing still images or video sequences, and mobile device cameras integrated into smartphones, tablets, laptops, webcams, or any other similar device, equipped with software and hardware elements for image verification. The term also extends to specialized cameras such as security or surveillance cameras, body-worn cameras, and dashboard cameras. Additional examples include action cameras designed for extreme conditions, such as those used in sports or outdoor activities; 360-degree cameras that capture immersive panoramic images; and webcams used for video conferencing that may include features for verifying captured content. “Camera device” further encompasses drones or other autonomous vehicles equipped with imaging sensors for aerial photography and mapping, as well as multi-camera systems that synchronize multiple lenses to create composite images or 3D renderings. The term may also refer to industrial cameras used in quality control processes, medical imaging devices such as endoscopes or surgical cameras, and cameras integrated into automotive systems for advanced driver-assistance features. Furthermore, “camera device” includes any modular or connected imaging system configured to work within a larger network or environment, including cameras embedded in IoT (Internet of Things) devices, all of which can generate, store, and transmit visual data.

In various embodiments of the systems, processes and methods described herein, a public-private key pair may be utilized to ensure secure data transmission, authentication, or access control within a system. A public-private key pair consists of a public key, which may be freely distributed and used to encrypt or verify data, and a corresponding private key, which is kept confidential and used to decrypt or sign data.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Generative artificial intelligence tools possess the capability to fabricate digital media content with such realism that professionals proficient in verification may struggle to discern these fabrications from authentic digital imagery. Whereas creating convincing forgeries once required significant skill, now, with accessible AI tools, almost anyone can manipulate or fabricate images and videos that can undermine trust and disrupt public order. These deepfakes and other realistic AI-generated content can spread false information about sensitive subjects, potentially inciting social, political, and security issues, as they create evidence of events or statements that never occurred. The current inability of cameras and image-capturing devices to embed reliable, verifiable data at the source exacerbates this problem, posing unique threats to the integrity of visual evidence in areas like journalism, law, and public safety.

Several solutions have been proposed to tackle the issue of media authentication, each with distinct drawbacks. Traditional methods, such as embedding cryptographic signatures directly in digital images, have been widely adopted but often fall short due to vulnerabilities in key management and storage. For instance, systems using public-private key cryptography require the private key to be stored on the camera. However, keys stored on a camera can be extracted and used to forge content, undermining the security of the entire system. Closed verification solutions created by some camera manufacturers, aimed at verifying media for trusted organizations like news outlets, lack scalability and accessibility for the general public. Emerging methods, such as incorporating depth-sensing technology and other metadata to authenticate images, have limitations, as generative AI is capable of replicating these features with increasing accuracy. Trusted Platform Modules (TPMs) and other secure hardware approaches, common in secure computing, could enhance camera security but require costly redesigns for consumer electronics and remain vulnerable to sophisticated attacks. In short, no single approach has emerged as both universally effective and practical for widespread use, leaving room for improvement in balancing robust security with usability and cost.

Additionally, ethical concerns arise when proprietary verification systems lack independent oversight, potentially compromising trust. While techniques from secure computing, such as TPM and hardware root of trust, offer promising frameworks, they require significant adaptation to function effectively in consumer devices like cameras.

There remains a need for an end-to-end authentication solution that is commercially viable, secure at the point of capture, and compatible with open verification.

The embodiments described herein allow for camera devices to generate an image that can be subsequently authenticated by a verifier system. The disclosed embodiments involve generating an authenticatable image that includes unique authentication image headers that can be encrypted using encryption keys. At least some of the disclosed embodiments additionally involve verifying the authenticity of an uploaded image using a verifier system that can extract and decrypt the authentication image headers from the image and perform checks of the data contained within. By verifying the authenticity of the image, the verifier system can determine if the image has been captured by a camera device or digitally created and in some cases, determine whether the image has been digitally altered.

The described embodiments provide a highly secure, efficient system for digital image authentication that uniquely ties camera hardware to digital images. Unlike existing systems which require camera modifications, the embodiments described herein deploy a low-cost approach that does not require alterations to the primary media processor. Instead, security is implemented via an add-on peripheral incorporating a low-cost identification tag and tag reader, which contain essential hardware identification information and cryptographic keys.

This design allows for simple and scalable manufacturing, making it commercially viable by eliminating the need for costly changes to existing camera architecture while adding robust security functionality. The described embodiments are compatible with existing camera models and can be integrated into the manufacturing process without the need for specialized equipment or for camera redesigns.

The disclosed embodiments involve generating unique encryption and decryption keys for encrypting and decrypting the authentication image headers. This design mitigates the risks associated with a single point of failure, as each camera operates with an autonomous key pair that does not depend on centralized key storage or management. At least some of the embodiments described herein involve generating random numbers using a generative AI model to generate one or more encryption keys, adding a layer of resilience to attacks, as truly, non-reversible random outputs can be generated. The random nature shields the key generation process from traditional code de-compilation attacks, further securing the cryptographic integrity of the camera.

The embodiments described herein eliminate the need for complex public-private key distribution frameworks, which are often cumbersome and vulnerable to attacks in traditional systems by storing cryptographic keys directly on the identification tag. The embodiments described herein involve storing cryptographic keys on the hardware itself, reducing the potential for exposure during transmission or storage.

At least one of the embodiments described herein enable ownership tracking of camera devices on a blockchain, allowing for secure ownership tracking.

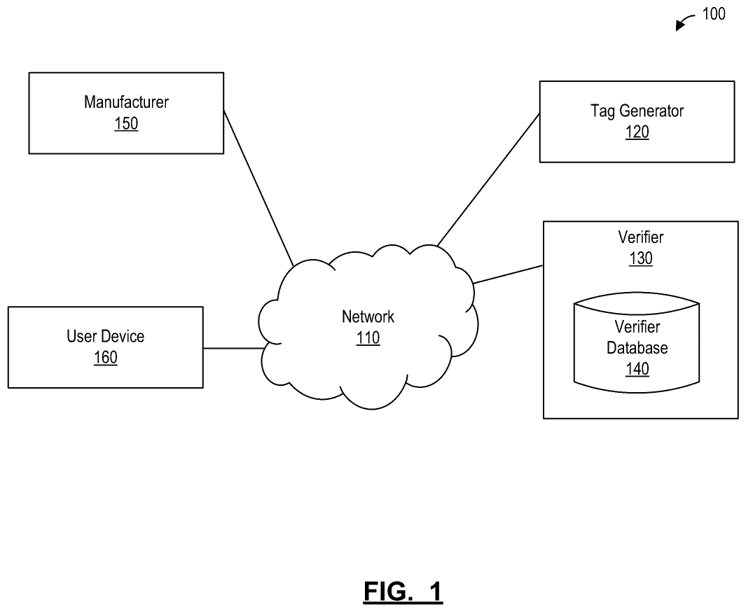

Reference is first made to FIG. 1, which shows a block diagram 100 of an authentication system for generating authentication information for images and for verifying the authenticity of images containing the authentication information. The authentication system 100 includes a tag generator 120 for generating identification tags, a verifier 130 for verifying the authenticity of images, a verifier database 140, a manufacturer 150 and one or more user devices 160, in communication with each other via a network 110.

The network 110 may be any network that allows each of the components of the system 100 to communicate. The network 110 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between each of the components of the authentication system 100.

The tag generator 120 generates identification tags affixable to camera devices for authenticating images produced by the camera devices. The tag generator 120 can generate records containing identification tag data and transmit instructions for encoding the records on tags to an encoding system (not shown). The identification tags can then be scanned at a later time to read the identification tag data.

The tag generator 120 can create identification tag data. The tag generator 120 can obtain information relating to batches of camera devices to be tagged and generate and/or retrieve cryptographic keys to encode information relating to the batches and generates records for the camera devices.

An encoding system (not shown) can receive the records to be encoded and instructions from the tag generator 120 and encode the records onto identification tags affixable to camera devices. The encoding system can include an encoding machine that receives instructions for encoding tags and carries out the encoding process.

The verifier 130 can verify the authenticity of an image. The verifier 130 can be a service provider and may operate through supplying a web-based service. The web-based service may be any service or application accessible via the internet that enables users to interact with, access, or manage data, software, or functions through a web browser or other internet-connected interface. This encompasses services delivered over cloud infrastructure, including software-as-a-service (Saas), platform-as-a-service (PaaS), and infrastructure-as-a-service (IaaS) models. The web-based service may provide real-time interaction, data storage, data retrieval, computational resources, or user-specific operations, and can integrate with multiple devices, such as user device 160, or systems through APIs, web portals, or other online protocols. For example, the web-based service may be a website that can be navigated to through a URL or an application that can be downloaded on a user device 160.

The verifier 130 can receive identification tag data from the tag generator 120 and manufacturing information from the manufacturer 150. The information received by the verifier 130 can be stored in verifier database 140.

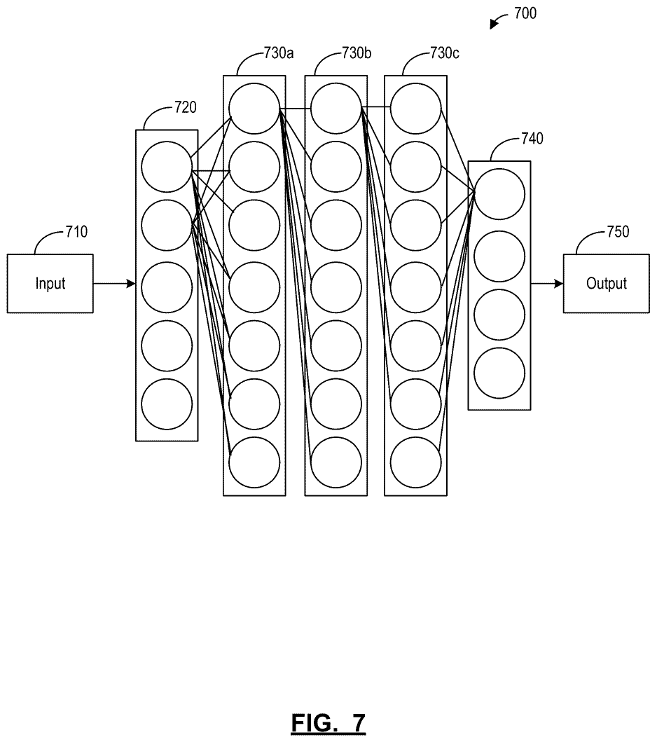

The verifier 130 can generate a verifier weights file. The verifier weights file can be a file, such as a binary file, used as input for a generative neural network, as will be described in further detail with reference to FIG. 7, to obtain information used for generating an image that may be authenticated and for authenticating an image. The verifier 130 can store the verifier weights file in the verifier database 140 in association with information about a camera device, a camera device model or a manufacturing batch of a camera device model and send the verifier weights file to manufacturer 150. Manufacturer 150 can incorporate the verifier weights file into the manufacturing process of the camera device. For example, the manufacturer 150 can embed the verifier weights file to the camera firmware of the camera device.

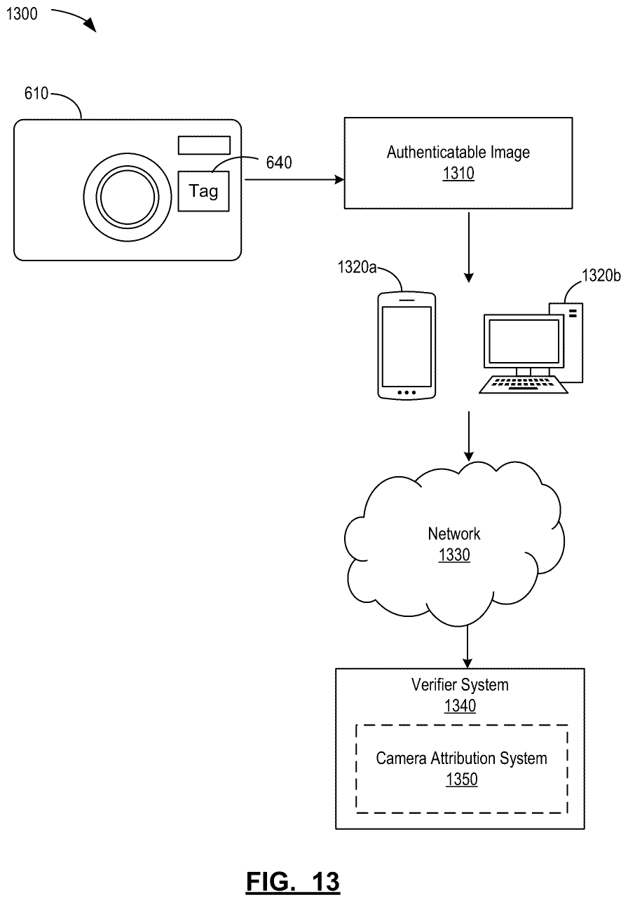

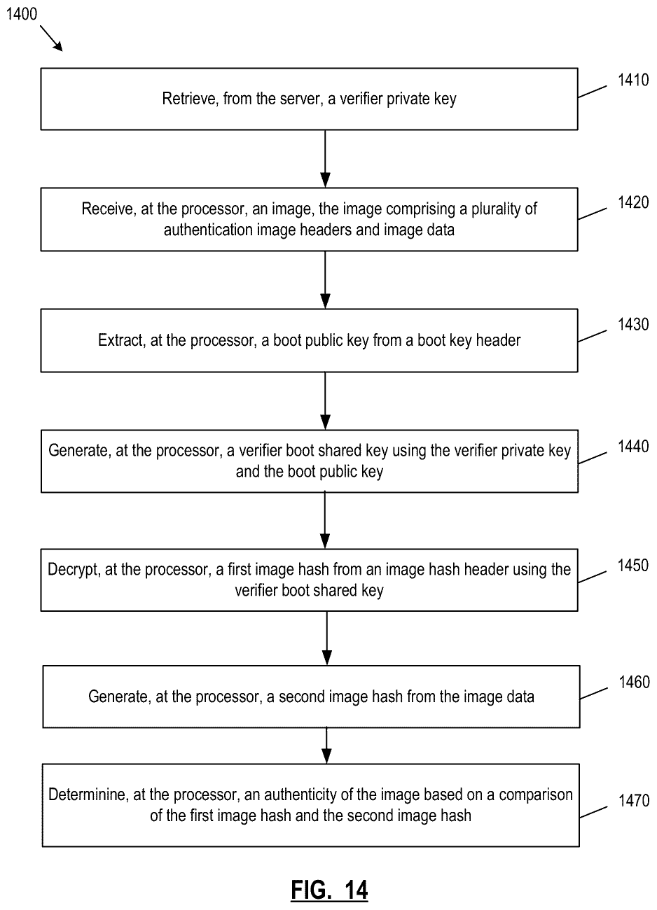

The verifier 130 can receive an image from user device 160 to be verified and verify the authenticity of the image through one or more checks, as will be discussed in further detail with reference to FIGS. 13-14. The verifier 130 may compare retrieved information from the verifier database 140 with encrypted authentication header information from the image to verify the authenticity of the image. The verifier 130 may perform decryption on the encrypted authentication header information to enable this comparison. The verifier 130 can output to the user device 160 or by any other notification means, a determination of the authenticity of an image.

In at least one embodiment, the verifier 130 can verify a status of a camera device to ensure that the camera device is a trusted device. For example, the verifier 130 may compare camera device identification information to a database of blacklisted camera devices. If the camera device matches a blacklisted camera device, the verifier 130 may provide a notification that can be displayed, for example, on the user device 160, stating as such.

The verifier 130 can store authentication information in the verifier database 140. The verifier database 140 can store any information relating to camera devices, camera device batches and associated identification tags affixed to the camera devices. A camera device batch corresponds to a pre-determined number of identical or similar cameras manufactured via batch production.

The verifier database 140 can also store any information that can be used by the verifier 130 to verify the authenticity of an image. For example, the verifier database 140 can maintain account records for manufacturer 150. The account records can store records for each batch of camera devices manufactured by manufacturer 150 including a batch identifier corresponding to the batch production in the manufacturing process and camera identifiers corresponding to camera devices manufactured in the batch production. The camera identifiers can include a Universally Unique Identifier (UUID) and a serial number assigned to the camera. The serial number assigned to the camera may be a number between 1 and n, where n is the number of camera devices in the batch.

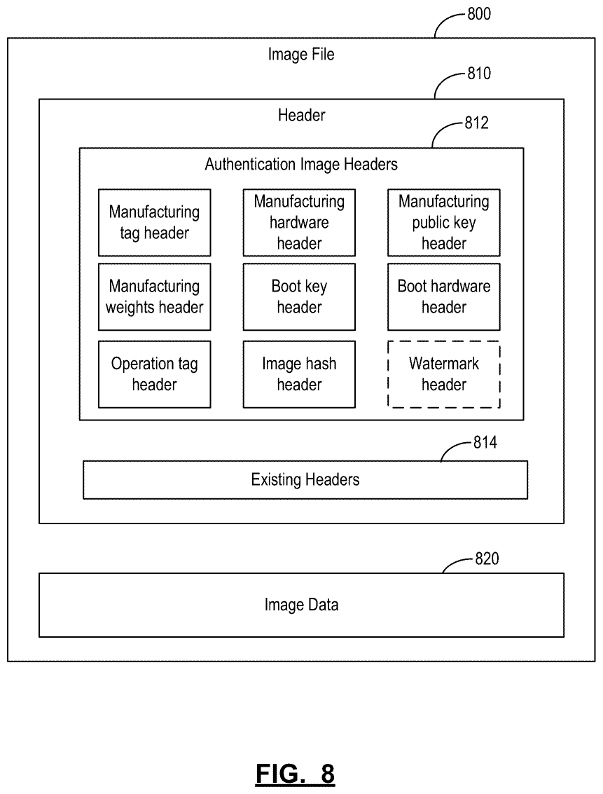

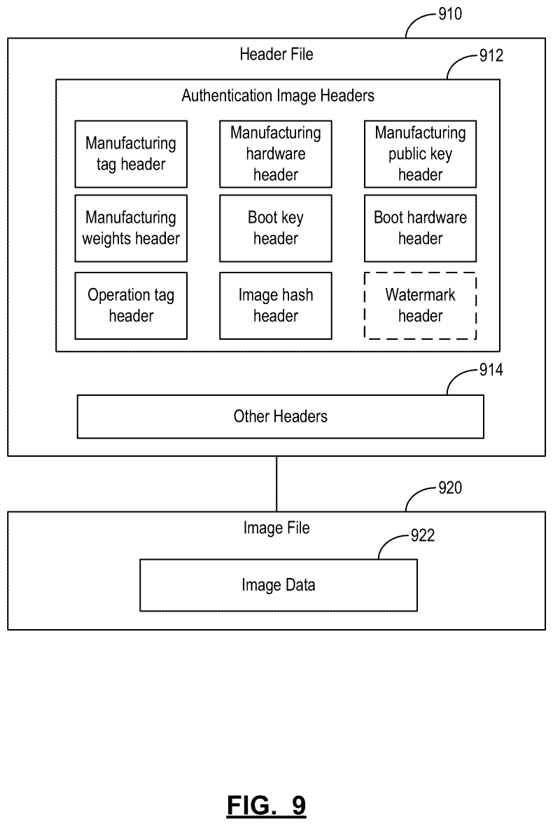

The verifier database 140 can store encryption and decryption keys for encrypting and decrypting tag information, as discussed in further detail below, with reference to FIGS. 8-9. The verifier database 140 can store other encryption and decryption information such as encryption algorithm details. The encryption algorithm details can include a verifier weights file and watermarking parameters. The verifier weights file can be used to initialize a generative neural network for encrypting image data, as discussed in further detail below, with reference to FIG. 7.

The verifier database 140 can store account records for more than one manufacturer 150. For example, each manufacturer may set up an account with the verifier 130. When a manufacturer 150 wishes to set up an account with the verifier 130, the verifier can push account information to the verifier database 140. When verifying the authenticity of an image, the verifier 130 can pull information from the verifier database 140. The information pulled from the verifier database 140 can be used to compare with information from an image to be authenticated.

The verifier database 140 can additionally store information relating to the attribution of camera devices, as explained in further detail with reference to FIG. 13. For example, when a camera device is attributed to an individual, the verifier database 140 can record the owner of the camera device.

The manufacturer 150 can be a manufacturer of camera devices. The manufacturer 150 can integrate the digital camera hardware and the camera software, which may be developed by the manufacturer 150 or a third-party in communication with the manufacturer 150. The manufacturer 150 may be responsible for manufacturing camera devices in their entirety, assembling certain components or subassemblies of camera devices, or integrating only the authentication components on the camera device. Although only one manufacturer 150 is shown in the block diagram 100 of FIG. 1, it will be understood that the authentication system 100 can include more than one manufacturer 150, each manufacturing camera devices or parts of camera devices.

The manufacturer 150 can order identification tags to be affixed to the camera device during the manufacturing process. To do so, the manufacturer 150 can transmit instructions to the tag generator 120 for generating identification tags. These instructions may include information, for example, camera model details and encryption parameters of the camera devices manufactured by the manufacturer 150. The manufacturer 150 can transmit new instructions to the tag generator 120 to generate identification tags for each new batch of camera devices.

As explained, the manufacturer 150 can set up an account with the verifier 130. The account information of the manufacturer 150 can be linked to identification tag information. Each manufacturer account can be linked to multiple sets of identification tag information, each set being associated with a different batch of camera devices. The account information of each manufacturer 150 can be stored in the verifier database 140. The manufacturer 150 may provide the verifier 130 with camera device-specific information to be used for later verification processes.

The manufacturer 150 can create the main camera firmware and embed it with tag reader firmware and a verifier weights file received from the verifier 130. The main camera firmware can be loaded during the camera manufacturing process through various secure data transfer interfaces, including but not limited to Universal Serial bus (USB), Universal Asynchronous Receiver-Transmitter (UART), or Secure Digital (SD) card insertion. For example, the camera device may be connected to a dedicated programming station, where the firmware is loaded onto the camera's internal storage via a high-speed USB interface or, alternatively, through a UART serial connection for devices with specific embedded requirements. Firmware may also be transferred via an SD card, inserted into the camera's dedicated slot, where the device recognizes and installs the firmware directly. During loading, a secure boot protocol may be activated to verify the integrity and authenticity of the firmware package, ensuring that only authorized, verified firmware is installed. Each camera device may undergo a validation step upon successful installation of the firmware to confirm that the firmware is correctly and completely loaded, activating the camera's operational features, authentication algorithms, and secure hardware modules. This process may include a confirmation of firmware functionality.

The manufacturer 150 can mechanically apply or affix an identification tag to the camera device during the physical integration of the camera device. The manufacturer 150 may also be responsible for any of the following: initializing the camera device and the tag reader; performing a camera test boot process; generating encryption or decryption keys to encode hardware and other authentication information; register the identification tag with the verifier 130; and prepare the camera device for shipping.

Each user device 160 couples to the network 110 through a wired or wireless connection to communicate with the verifier 130. Each user device 160 can include a processor and a memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. Each user device 160 can be associated with an individual seeking to verify the authenticity of images and/or to claim attribution for a camera device, though each individual can be associated with more than one user device 160. The user device 160 can be used to retrieve information on identification tags affixed to camera devices. In at least one embodiment, the user device 160 is equipped with wireless scanning functionalities that allow the user device 160 to read information encoded on identification tags. The user device 160 can be used to verify the authenticity of images and to receive information from the verifier 130.

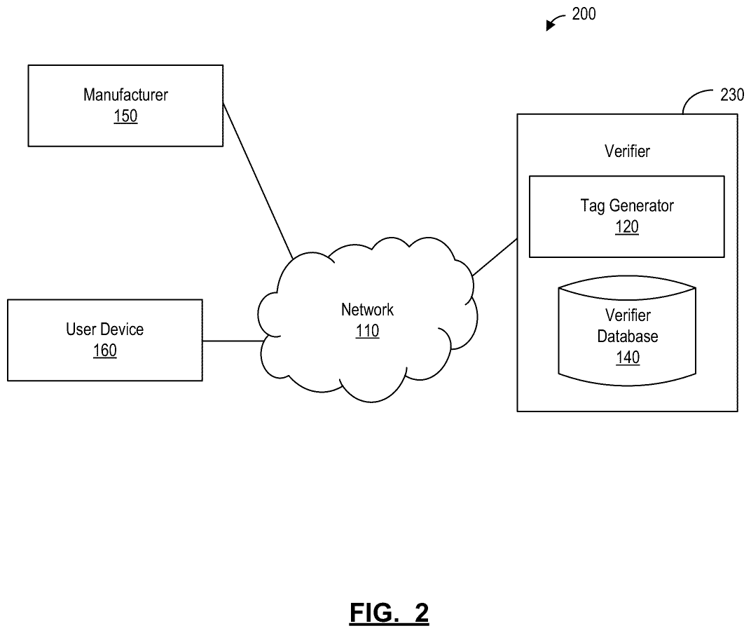

Referring now to FIG. 2, there is shown a block diagram 200 of an authentication system for generating authentication information for images and for verifying the authenticity of images containing the authentication information, according to another embodiment. The authentication system 200 of FIG. 2 can be substantially similar to the authentication system 100 of FIG. 1. However, in the authentication system 200, the verifier 230 includes the tag generator 120 and the verifier database 140. The verifier 230 can perform the functions of verifier 130, as described with reference to FIG. 1, in addition to the functions of tag generator 120, as described with reference to FIG. 1.

The verifier 230 can receive instructions from the manufacturer 150 for generating identification tags. The verifier 230 can generate identification tags which are affixed to camera devices by the manufacturer 150 during the manufacturing stage.

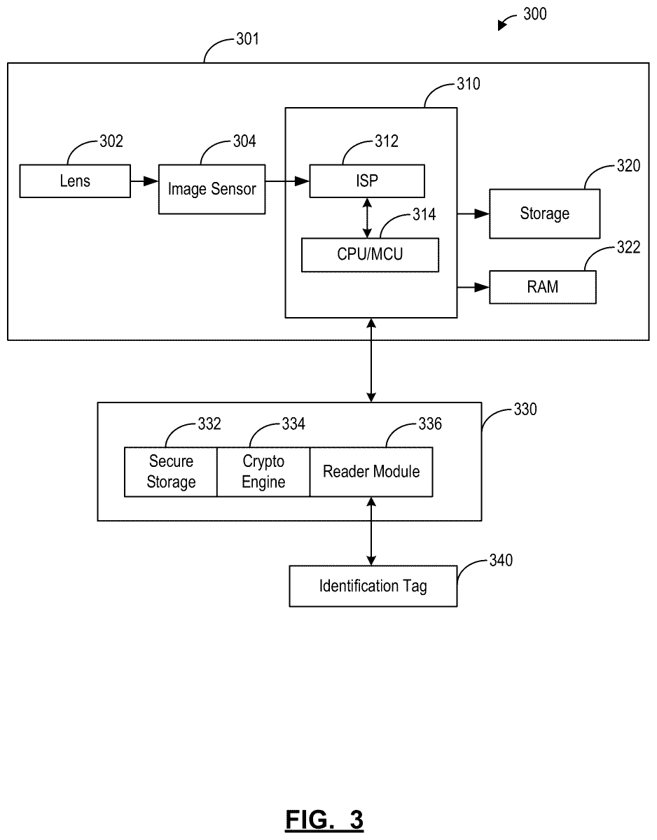

Referring now to FIG. 3, there is shown a block diagram of components of an example camera device 300 that can be used to generate images that can authenticated. As shown in the example of FIG. 3, the camera device 300 includes imaging system 301, tag reader 330, and an identification tag 340. Imaging system 301, tag reader 330, and/or identification tag 340 can be physically connected to one camera device. In some embodiments, imaging system 301 is housed in a digital camera body.

Imaging system 301 can be any imaging system as is known to those skilled in the art of imaging systems implemented in a digital camera. For example, imaging system 301 may be a set of off-the-shelf hardware components found on a digital camera. Imaging system 301 can include any additional components typically found in a digital camera such as a global positioning system (GPS) chip, inertial measurement unit (IMU) chip, light level sensors, flash hardware, networking hardware (e.g. Bluetooth, Wi-Fi, and long-term evolution hardware), and application-specific sensors (e.g. motion detection sensors).

Imaging system 301 includes a lens 302, an image sensor 304, a processing system 310, storage module 320, and RAM 322.

Lens 302 can be any suitable lens for a digital camera. In various embodiments, the digital camera lens assembly may include fixed or variable focal lengths, adjustable apertures, and optical or sensor-based image stabilization for enhanced image quality under diverse conditions. Lens 302 can have zoom capabilities or incorporate specialized elements. Lens 302 can be an interchangeable lens.

Lens 302 focuses light from a scene onto image sensor 304, enabling the capture of image. Image sensor 304 captures and converts light into digital signals. Image sensor 304 may comprise a CMOS (complementary metal-oxide-semiconductor) or CCD (charge-coupled device) architecture. In some embodiments, image sensor 304 includes backside-illuminated (BSI) technology.

Image sensor 304 can output digital data representing the captured image. For example, image sensor 304 can output an unprocessed, high-resolution raw image file. This raw image file can be sent to ISP chip 312.

Processing system 310 can include an image signal processing (ISP) chip 312 and a central processing unit/microcontroller unit (CPU/MCU) chip 314. The ISP chip 312 can handle image processing while a separate CPU/MCU chip 314 manages overall system operations. In some embodiments, the processing system 310 includes a CPU/MCU chip with built-in ISP functionality. The processing system 310 can be integrated into a single system-on-a-chip (SoC). In other embodiments, the processing system 310 includes a multicore SoC with integrated ISP functionality. The processing system 310 can use an SoC with multiple cores, wherein one core is dedicated to ISP functionality, while other cores handle general processing. In yet further embodiments, processing system 310 includes more than one ISP chip 312, wherein each ISP chip is dedicated to further tasks. Processing system 310 can include any other component that may be found in the processing system of a digital camera such as: a graphics processing unit (GPU) chip, a field-programmable gate array (FPGA), and a neural processing unit (NPU).

ISP chip 312 can perform image processing on images capture by the camera system 300. ISP chip 312 can be an application-specific integrated circuits (ASIC), an FPGA, or combined with a CPU/MCU chip 314 in a single die. ISP chip 312 can have a complex chip design that may be custom and closed source to the camera manufacturer. ISP chip 312 can convert raw image data from image sensor 304 into a viewable image through performing a series of specialized operations. For example, ISP chip 312 can convert image data into formats such as JPEG, RAW, TIFF, PNG, BMP, HEIF, proprietary formats specific to the camera manufacturer, MP4, MP5, H.264, H.265 (HEVC), VP9, AV1, ProRes, or HDR formats or any other image or video file format.

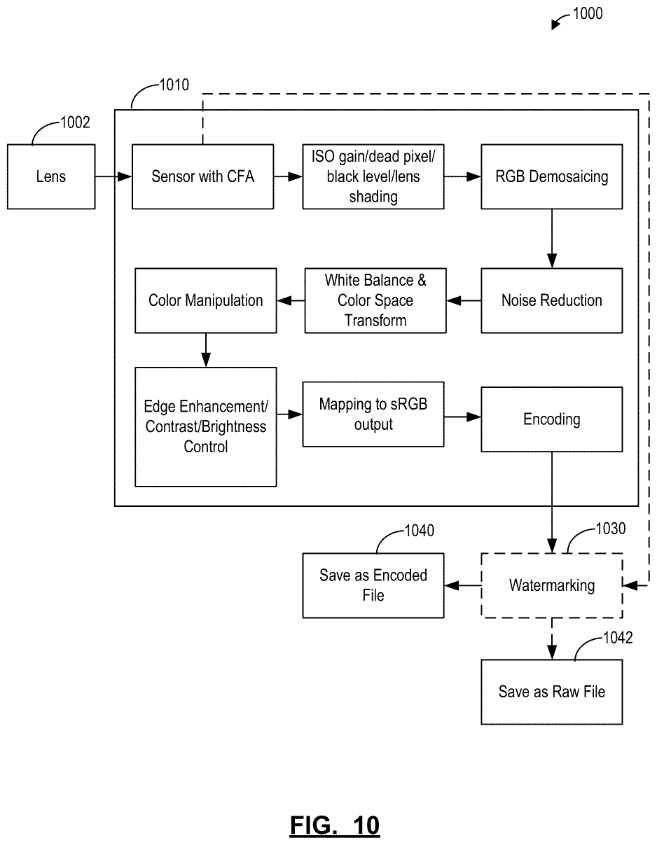

ISP chip 312 can execute a series of image processing functions including, but not limited to, noise reduction, white balance adjustment, demosaicing, correction of lens distortion, hot pixel fixes, dead pixel fixes, edge sharpening, gamma correction, dynamic range compression or expansion, image scaling, and color correction. Processing performed by ISP chip 312 is further discussed in relation to FIG. 10.

In some embodiments, the processing logic of ISP chip 312 is accessible through predefined ISP registers or by uploading specific binary data files for tasks such as lens correction. In embodiments where ISP chip 312 is implemented as an FPGA or as an ASIC, ISP chip 312 can be designed with an architecture that permits extraction, replacement, or reconfiguration of its logic functions.

CPU/MCU chip 314 can implement any suitable operating system. In some embodiments, CPU/MCU chip 314 employs a real-time operating system (RTOS). In other embodiments where the camera system 301 is integrated within a multifunctional device such as a smartphone or table, the CPU/MCU chip 314 operates under a mobile operating system-environment, such as IOS, Android, or an equivalent.

CPU/MCU chip 314 performs control, processing, and management functions, with the goal of enabling image capture. CPU/MCU chip 314 can process commands from user inputs and interface with storage components such as storage module 320 and RAM 322. CPU/MCU chip 314 can direct communication between image sensor 304 and ISP chip 312. Additionally, CPU/MCU chip 314 can manage power distribution. In some embodiments, camera system 300 is connected to a network and CPU/MCU chip 314 supports wireless protocols, enabling image transfer, remote control, and firmware updates.

CPU/MCU chip 314 can incorporate and execute firmware. For example, CPU/MCU chip 314 can execute main firmware, autofocus firmware, exposure and metering firmware, image processing firmware, lens firmware, network and connectivity firmware, RTOS firmware, and diagnostic firmware. The main firmware of imaging system 301 can be embedded with a verifier weights file and reader firmware, as discussed further below with reference to FIGS. 7-9, and 12.

Tag reader 330 can communicate with CPU/MCU chip 314 and identification tag 340. In some embodiments, tag reader 330 and CPU/MCU chip 314 can be designed as one chip. Tag reader 330 can include a TPM or have features to securely store cryptographic keys and perform secure computation on data.

Tag reader 330 can generate an electromagnetic field to power a passive identification tag 340. Alternatively, tag reader 330 can establish a connection with an active identification tag 340. Tag reader 330 can interpret data (e.g., identification information) received from identification tag 340 and send this data to imaging system 301. Tag reader 330 can also receive data from imaging system 301, and specifically CPU/MCU chip 314, and pass this data to identification tag 340. Tag reader 330 can communicate with CPU/MCU chip 314 via several methods including i2c, i3c, SPI, or any proprietary standard.

In some embodiments, tag reader 330 can be an NFC (Near Field Communication) reader. In other embodiments, tag reader 330 can be an RFID (Radio Frequency Identification) reader.

Tag reader 330 can be initialized with tag reader firmware by the manufacturer 150. Tag reader firmware can verify the authenticity of the main firmware of imaging system 301 by comparing a computed hash and a signed hash from CPU/MCU chip 314.

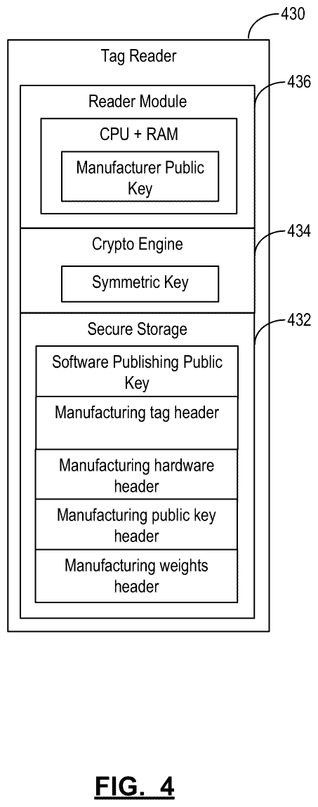

Tag reader 330 comprises secure storage 332, crypto engine 334, and reader module 336. Secure storage 332 is a specially protected area of memory designed to store sensitive data such as authentication data that only authorized readers can access or modify. Secure storage 332 can be configured as WORM (Write Once, Read Many) storage or as a rewritable secure storage. Secure storage 332 will be described in further detail with reference to FIG. 4.

Crypto engine 334 can be a dedicated hardware or software module that performs cryptographic operations. Crypto engine 334 can enable secure communication with identification tag 340 and CPU/MCU chip 314. Crypto engine 334 will be described in further detail with reference to FIG. 4.

Reader module 336 can detect, power and communicate with identification tag 340. Reader module 335 can interpret signals from identification tag 340, allowing data to be read from or written to identification tag 340. Reader module 336 will be described in further detail with reference to FIG. 4.

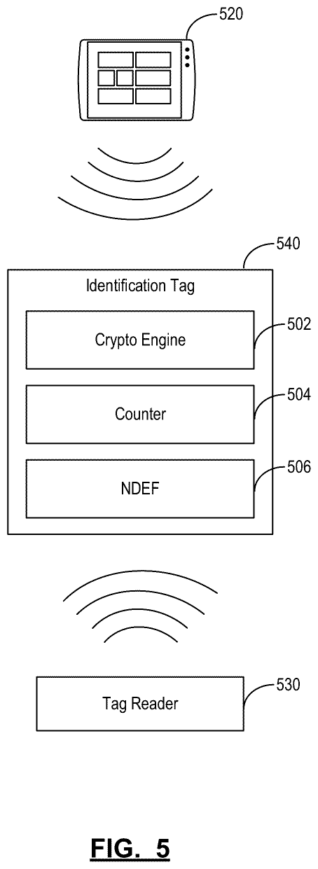

Identification tag 340 stores identification and authentication information used to authenticate and verify the authenticity of images. Identification tag 340 can be passive or active and can pass identification information to tag reader 330 and an external reader such as external reader 520, shown in FIG. 5, through wireless communication protocols.

Identification tag 340 can be a tag that uses any type of near field or contactless technology. In some embodiments, identification tag 340 can be an NFC tag. In other embodiments, identification tag 340 can be a passive or active RFID tag. Identification tag 340 can be designed as a tamper-proof identification tag. For example, identification tag 340 can include an inductive or capacitive tamper loop to detect removal from the camera device.

Upon reading of identification tag 340 by tag reader 330 or an external reader, identification tag 340 can return one or more data fields. The data fields can be formatted as a URL. The data fields can include identification tag data which can include but is not limited to Universally Unique Identifier (UUID), a tap count, a checksum, a batch ID, a batch creation time, a serial number, and a verifier public key. At least some of the fields can be used for generating authentication data and/or for verifying the authenticity of images. In some embodiments, some of the fields can be omitted. The data contained in the data fields may be different on each read by tag reader 330 or an external reader. The data fields can be encrypted using an encryption key stored on a crypto engine, such as crypto engine 502 shown in FIG. 5, which will be described in further detail below. For example, the data fields can be encrypted using an AES (Advanced Encryption Standard) algorithm.

Referring briefly to FIG. 5, there is shown a block diagram illustrating an example identification tag 540 communicating with tag reader 530 and external reader 520 using NFC. Identification tag 540 can be substantially similar to identification tag 340. Tag reader 530 may be substantially similar to tag reader 330 and tag reader 400. As shown in FIG. 5, example identification tag 540 communicates with tag reader 530 and external reader 520 using wireless NFC.

External reader 520 can be any type of reader device capable of reading NFC tags. For example, external reader 520 can be any commonly available NFC reader (e.g., smartphones, tablets, wearable devices, laptops with built-in NFC readers) or a purpose-built NFC reader. It will be understood that identification tag 540 is shown to be an NFC tag by way of example, only and that identification tag 540 can work as an RFID tag, Bluetooth tag, or similar tag and external reader 520 can be a handheld RFID reader, a fixed RFID reader, a desktop or tabletop reader, or a Bluetooth-enabled RFID reader or any other reader for similar tags.

Identification tag 540 includes a crypto engine 502, a counter 504, and an NDEF (NFC Data Exchange Format) module 506. Crypto engine 502 can perform cryptographic operations for secure data handling and communication. Crypto engine 502 enables encryption and decryption of data stored on the tag and facilitates secure interactions with compatible reader devices such as tag reader 530 and external reader 520. Crypto engine 502 can utilize cryptographic algorithms, such as AES or RSA, to execute processes like mutual authentication, data integrity verification, and encryption of sensitive information. Crypto engine 502 may also generate or manage cryptographic keys. Crypto engine 502 may store identification tag data.

Counter 504 can be a module that logs each time the identification tag 540 is scanned by a tag reader 530 or an external reader 520. Counter 504 can keep track of the number of reads or taps of the identification tag 540 for later use in the authentication process, as discussed further below. Counter 504 can be a monotonic counter that starts with a counter value of zero and increases by one on every new read.

NDEF module 506 is a dedicated data structure and processing component that enables standardized storage and communication of information between identification tag 540 and tag reader 530 or external reader 520. NDEF module 506 can organize data in a well-defined format that includes multiple data fields, such as in a URL. NDEF module 506 can include functionality to read, write and manage data fields and ensure data is stored in compliance with NFC Forum standards.

Returning to FIG. 3, identification tag 340 can be affixed to the camera device 300 in any location such that identification tag 340 is readable by tag reader 330 and an external reader. For example, identification tag 340 can be affixed to the inner surface of the camera body. Alternatively, identification tag 340 can be affixed to the outer surface of the camera body. Identification tag 340 can be affixed to the camera device with any secure method that is difficult to remove, as selected by manufacturer 150. For example, identification tag 340 can be affixed using an adhesive such as a high-strength, industrial-grade adhesive. Adhesive fixing may be in an internal compartment, such as near the battery slot or under a secured panel, which limits unauthorized access to the tag. Alternatively, identification tag 340 is affixed to the camera device through an insertable tray (e.g., similar to SIM card tray modules used on mobile devices). Other methods of affixing identification tag 340 to the camera devices include but are not limited to, embedded slot mounting wherein identification tag 340 is snugly embedded into a custom-designed slot within the camera device body, and encapsulation of identification tag 340 within the camera body during the molding process.

The manufacturer 150 manufactures camera system 300, shown in FIG. 3, through a manufacturing process. The manufacturer 150 can manufacture and assemble all components of camera system 300. For example, the manufacturer 150 can assemble all components of imaging system 301 and integrate tag reader 330 and identification tag 340. In other embodiments, the manufacturer 150 manufactures and assembles a subset of components of camera system 300.

The manufacturer 150 can create the firmware of the camera system 300. For example, the manufacturer 150 can develop the main firmware of the camera system. The main firmware of the camera system can be embedded with a verifier weights file received from a verifier, such as verifier 130 or verifier 230. The verifier weights file can be used by the main camera firmware to generate a deterministic sequence of numbers based on a secret input of a seed value and a secret prompt. The verifier weights file may be issued per camera device, camera device model or per manufacturing batch of a camera device model. The main firmware of the camera system can also be embedded with tag reader firmware. In some embodiments, the manufacturer 150 can release main firmware that does not include tag reader firmware.

The manufacturer 150 can load firmware into the camera system 300 via any process, as described herein, during the manufacturing process.

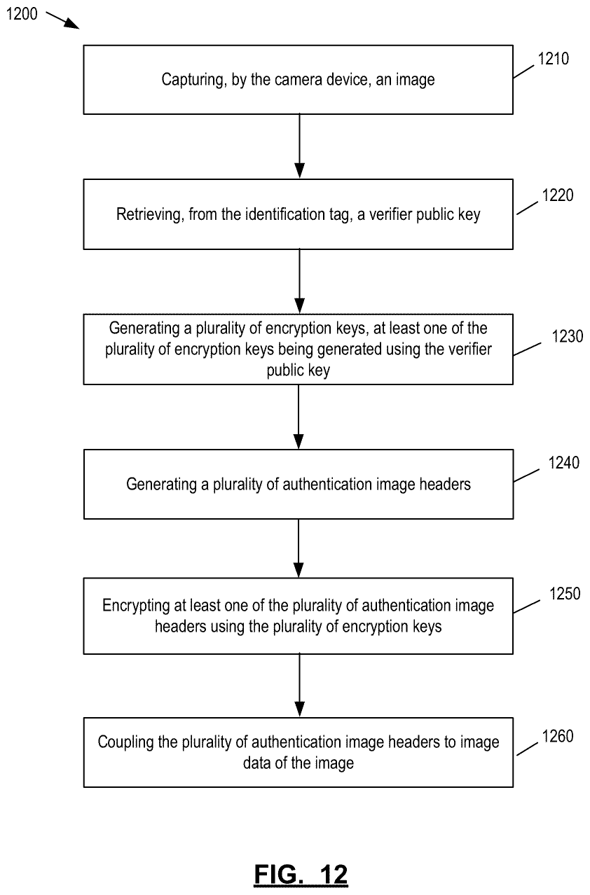

The manufacturer 150 can order identification tags from tag generator 120. The manufacturer 150 can specify the type (e.g., physical form factor) and number of identification tags required in the order. The number of identification tags can correspond to the number of items in the batch. For example, for each batch of camera devices, the manufacturer 150 may order a new batch of identification tags. For each batch of identification tags, the tag generator 120 may generate a new verifier key pair consisting of a verifier private key and a verifier public key {Vprk, Vpuk}. The identification tags can be encoded using an encoding machine. The encoding machine can be a device that writes data onto the memory of the identification tag 340. The machine may be at the manufacturing site of manufacturer 150 or at a remote location. The encoding machine can securely receive instructions for encoding tags and carry out the encoding process. The encoding machine can encode the verifier public key and a symmetric key onto the identification tags ordered by the manufacturer 150. The verifier public key and the symmetric key are described in further detail with respect to FIG. 12.

The manufacturer 150 can manually or automatically apply identification tag 340 to the camera body. Identification tag 340 can be affixed to the camera body in any location as previously described.

Once the manufacturer has applied identification tag 340 to the camera body, the manufacturer 150 can perform a camera test boot process. The camera test boot process can involve reading, by a tag reader, identification tag data from an identification tag affixed to the camera device such as identification tag 340.

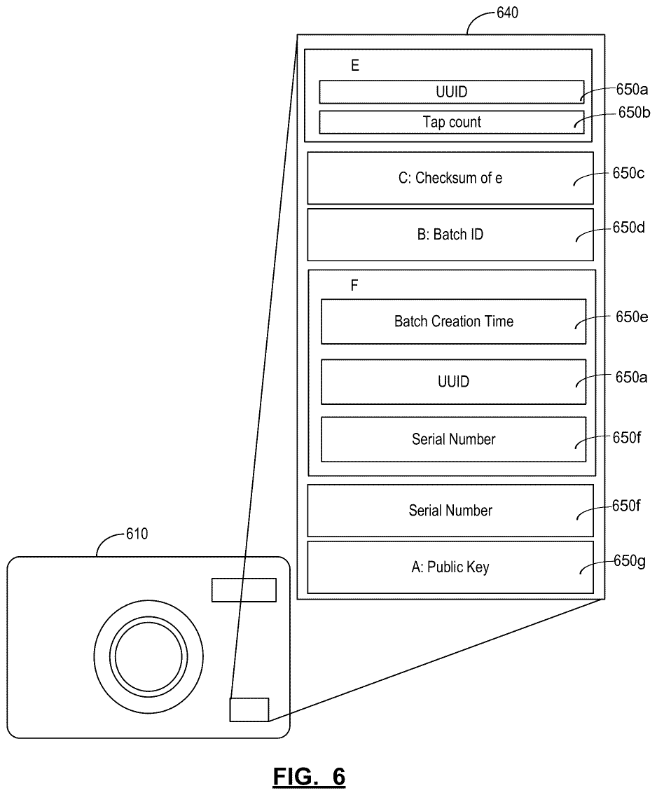

Referring briefly to FIG. 6, there is shown a schematic diagram of an example identification tag 640 affixed to a camera device 610. Camera device 610 can include the components of camera device 300. As shown in the example of FIG. 6, identification tag 640 is encoded with information including a Universally Unique Identifier (UUID) 650a, a tap count 650b, a checksum 650c, a batch ID 650d, a batch creation time 650e, a serial number 650f, and a verifier public key 650g. The tap count can be a writable field that is updated each time the tag is scanned. For example, the tap count can indicate the number of times that the tag has been scanned. The serial number can be a serial number assigned to the camera device. For example, the serial number can be assigned by verifier 130 or verifier 230 for each camera in a batch and can be a number between 1 and n, where n is the number of camera devices in the batch. Identification tag 640 can be substantially similar to identification tag 340.

The verifier public key can be the public key in a public-private key pair generated by verifier 130 or verifier 230. The verifier public key can be generated for a specific batch of camera devices. In other words, the verifier public key can be constant for all camera devices across a batch.

Reading the identification tag 640 can return several data fields of identification tag data as a URL. For example, identification tag 640 can return a URL of the type: https://verifier?e=E&c=C&b=B&F=f&sno=SNO&a=A, where ‘e’ is an encrypted field comprising a UUID 650a and a tap count 650b; ‘c’ is a variable checksum 650c of ‘e’; ‘b’ is a constant batch ID 650d; ‘f’ is an encrypted field comprising a UUID 650a, a batch creation time 650e, and a serial number 650f created on an encoding machine; ‘sno’ is a serial number assigned to the camera device 650f; and ‘a’ is the verifier public key 650g.

The manufacturer 150 can initialize the tag reader 330 or tag reader 430, shown in FIG. 4. Referring now to FIG. 4, there is shown a schematic diagram of an example tag reader 400. Tag reader 400 includes reader module 410, crypto engine 420, and secure storage 430. Initializing tag reader 400 can include storing data in the various components of tag reader 400.

Reader module 410 can include a CPU+RAM module. Firmware for tag reader 400 can be flashed to the CPU+RAM module during manufacturing. In some embodiments, the firmware for tag reader 400 can include a manufacturing public key. The manufacturing public key can be a cryptographic key generated by the manufacturer 150.

Crypto engine 420 can be a specialized component designed to perform cryptographic functions directly on identification tag 340 or identification tag 640. Crypto engine 420 can enable secure data storage and transmission by processing cryptographic algorithms (e.g., AES, RSA) to protect sensitive information. For example, crypto engine 420 can store a symmetric key. The symmetric key can be used to encrypt identification tag data. The symmetric key may not be accessible once it is written to crypto engine 420 and may only be used by sending encrypted data to and receiving decrypted data from crypto engine 420. The generation, storage and use of the symmetric key will be further discussed in relation to method 1200.

Secure storage 430 is a protected memory area of tag reader 400 used to store sensitive data, such as encryption keys and authentication credentials. Secure storage 430 can be substantially similar to secure storage 332 described with reference to FIG. 3. Access to secure storage 430 can be restricted through security mechanisms like encryption and authentication, allowing only authorized readers to read or modify the stored data. Secure storage 430 can store a software publishing public key and a plurality of authentication image headers. The plurality of authentication image headers can include a manufacturing tag header, a manufacturing hardware header, a manufacturing public key header, and/or a manufacturing weights header, which will be described in further detail with reference to FIG. 12.

During the manufacturing process, the camera device can retrieve from the identification tag 640, a verifier public key; generate a plurality of encryption keys using the verifier public key; generate a plurality of authentication image headers; encrypt the plurality of authentication image headers using at least one encryption key; and load the authentication image headers into secure storage 430, as will be discussed in further detail with respect to FIGS. 7-9 , and 12.

The manufacturer 150 can register identification tag data with verifier 130 or verifier 230. This process of registering identification tag data may involve creating a manufacturing record at the verifier. The manufacturer 150 can read identification tag data from identification tag 640 or identification tag 340 using an external reader such as external reader 520. The identification tag data, including a manufacturing tap count, can be sent to the verifier. The verifier can store the identification tag data. The manufacturing tap count is an important parameter that is sent to the verifier during the manufacturing stage. The manufacturing tap count sets a lower count threshold for all images taken on the camera device. Images uploaded to the verifier can be, in part, verified by checking that the tap count of the image is higher than the manufacturing tap count.

The manufacturer 150 can register further information with verifier 130 or verifier 230. For example, the manufacturer 150 can register camera device information including a photo of the camera device and marketing material for the camera device. Additionally, the manufacturer 150 can register shared secrets with the verifier 130 which can be used by the verifier 130 to verify the authenticity of images captured on the registered camera devices. The shared secrets can include camera hardware parameters such as the number of hardware identifiers and the order of reading the hardware identifiers. Hardware identifiers are used to identify hardware components of the camera device. Examples of hardware identifiers include, but are not limited to a CPU serial number, a Wi-Fi serial number, storage serial number, image sensor ID, battery serial number, GPS module ID, and lens ID. Each manufacturer, where there is more than one manufacturer 150, can determine their own camera hardware parameters. The camera hardware parameters can be stored in authentication image headers on a tag reader and coupled to an image.

The shared secrets can include a hash of concatenated parameters for a secret curve used to add a watermark to an image. For example, a shared secret can be a SHA256 hash of parameters ‘A’ and ‘B’ for the secret curve y²=x³+Ax+B. The parameter for the secret curve can be hashed using any currently available hashing functions as well as any newly developed hashing functions in the future. The shared secrets can also include a number of pixels that are altered by the watermarking process. The number of pixels can be any number greater than one.

The shared secrets can further include a watermarking algorithm. In at least one embodiment, this can be computer code in a scripting language (e.g., python or typescript), compiled code, or an API (application programming interface) call. An example algorithm for watermarking sets watermarked pixel RGB values to the average value of all immediately surrounding pixels.

The manufacturer 150 can perform any other manufacturing processes to prepare the camera device 300, 610 for shipping and consumer use. For example, the manufacturer 150 can implement a secure boot system on the camera device to further harden the system. The secure boot system can involve using a ROM-based boot loader and checking for the integrity of the firmware image and/or of the hardware upon booting the camera device. Once the camera device is prepared, a user may use the camera device 300, 610 to capture images that may be authenticated.

Referring now to FIG. 12, there is shown a flowchart of an example method 1200 for generating an authenticatable image by a camera device, such as camera devices 300, 610. The method 1200 can generate an image that can later be authenticated using the method described in FIG. 14. Though the steps 1210-1260 are shown in a specific sequential order in FIG. 12, as will be described in further detail below, the steps need not be performed in the order shown and some of the steps may be performed in parallel.

At 1210, the camera device 300 captures an image. For example, when a shutter button is pressed on the camera device 300, light from the scene is directed through lens 302, which focuses the light onto image sensor 304. The image sensor 304 can receive the focused light and convert it into analog electrical signals that represent the captured scene. An Analog-to-Digital Convertor (ADC) chip can convert the analog signal into a digital signal. The ADC chip can be integrated into the image sensor 304 or may be an independent chip. ISP chip 312 receives the digital signal. ISP chip 312 is purpose-built to create an image frame and can perform initial processing steps such as Bayer demosaicing, noise reduction, color correction, sharpening, compression, or any other suitable processing. ISP chip 312 sends the digital image data to the CPU/MCU chip 314 for additional processing. CPU/MCU chip 314 can temporarily store the image data in RAM 322.

At 1220, the tag reader, such as tag reader 330, 430, or 530, retrieves, from the identification tag, such as identification tag 340, 540, or 640, a verifier public key. The verifier public key can be retrieved by reading a URL from the identification tag that contains the verified public key in one of the fields of the URL. For example, as explained with reference to FIG. 3, the identification tag 340, 540, 640 can return a URL when read by the tag reader 330, 430, 530. In the example URL https://verifier?e=E&c=C&b=B&F=f&sno=SNO&a=A, field ‘a’is the verifier public key.

At 1230, the camera device 300 generates a plurality of encryption keys. At least one of the encryption keys is generated using the verifier public key retrieved at 1220. The plurality of encryption keys can be generated by one or more processors on the camera device 300, such as CPU/MCU chip 314 and/or crypto engine 334 or 434. In some embodiments, the plurality of encryption keys is generated on a single processor. For example, the plurality of encryption keys can be generated and stored on crypto engine 334 or 434. In this example, the encryption keys do not need to be transmitted between the CPU/MCU chip 314 and crypto engine 334 or 434, which can minimize the likelihood that the encryption keys are intercepted. The encryption keys can include at least a subset of: a verifier key pair, a local key pair, a camera temporary shared key, a verifier temporary shared key, a boot key pair, a camera boot shared key, a verifier boot shared key, a symmetric key and/or a verifier symmetric key. The encryption keys will be described in further detail below.

At 1240, the camera device 300 generates a plurality of authentication image headers. The plurality of authentication image headers can be generated by a processor on the camera device, such as CPU/MCU chip 314 or crypto engine 334 or 434. The authentication image headers can include at least a subset of: a manufacturing tag header, a manufacturing hardware header, a manufacturing public key header, a manufacturing weights header, a boot key header, a boot hardware header, an operating tag header, an image hash header and/or a watermark header. The authentication image headers will be described in further detail below.

The encryption keys and the authentication image headers can be generated during the manufacturing process, upon a user booting the camera device 300 and/or at fixed intervals during camera operation or for each captured image. For example, a first subset of the encryption keys and/or the authentication image headers can be generated during the manufacturing process, a second subset of the encryption keys and/or the authentication image headers can be generated upon the user booting the camera device 300 and a third subset of the encryption keys and/or the authentication image headers can be generated at fixed intervals during camera operation or for each captured image. At least some of the encryption keys and the authentication image headers can be generated prior to 1210.

To generate at least some of the encryption keys and the authentication image headers, the processor can use identification tag data. When the tag reader 330, 430, 530 reads the identification tag 340, 540, 640, the processor of the camera device 300 can receive all identification tag data from the identification tag 340, 540, 640, such as fields ‘e’, ‘c’, ‘b’, ‘f’, ‘sno’, and ‘a’ as shown in the example URL above. For example, the tag reader 330, 430, 530 can read the identification tag data and transmit the identification tag data to the processor of the camera device 300.

At 1250, at least some of the authentication image headers are encrypted using the plurality of encryption keys.

Steps 1230, 1240 and 1250 can be performed simultaneously or sequentially. For example, the authentication image headers can be encrypted as they are generated.

The local key pair is a key pair that includes a local private key and a local public key: {Lprk, Lpuk}. In at least one embodiment, the local key pair is generated using an elliptic curve Diffie-Hellman (DH) approach.

Alternatively, the local key pair can be generated using other secure algorithms for generating a symmetric cryptographic key pair that are not vulnerable to security threats. Other secure algorithms include but are not limited to Rivest-Shamir-Adleman (RSA) key exchange, Finite Field Cryptography (FFC) DH variants, post-quantum key exchange algorithms, EIGamal key exchange, McEliece key exchange, or SIDH (Supersingular Isogeny Diffie-Hellman).

The camera temporary shared key, Sₜ, can be an encryption key. The camera temporary shared key, Sₜ, can be generated during the manufacturing process. The camera temporary shared key, Sₜ, can be used to encrypt an authentication image header, as will be described below. The camera temporary shared key, Sₜ, can be temporarily stored by the processor and can be discarded after the camera temporary shared key Sₜ is used for encrypting an authentication image header.

In some embodiments, the camera temporary shared key, Sₜ, can be generated by combining the local private key, Lprk, previously generated and the verifier public key, Vpuk, retrieved at 1220. However, in various other embodiments, the camera temporary shared key combining the local private key and the verifier public key is not directly used to encrypt an authentication image header. Instead, in such embodiments, the local private key and the verifier public key are used to create a derived camera temporary shared key by using a HMAC (Hashed Message Authentication Code)-based Key Derivation Function (HKDF) or a custom hash function.

In various embodiments, the derived key is generated using a unique, arbitrary or random value, or a nonce (‘number used once’), where (Sₜ=HASH (S_{t+some random parameters})). In some embodiments, the nonce is the random hex numbers generated via the neural network random generator disclosed herein.

The use of the derived key as the camera temporary shared key ensures that a different or a unique camera temporary shared key is used during each session/hardware and is bound to random parameters that link to the camera firmware and the tag hardware.

The manufacturing tag header can be an authentication image header that is generated by encrypting identification tag data retrieved at 1220, using the camera temporary shared key previously generated during manufacturing process. For example, the manufacturing tag header can include a URL such as example URL https://verifier?e=E&c=C&b=B&F=f&sno=SNO&a=A, encrypted using the camera temporary shared key.

The manufacturing hardware header can be an authentication image header that is generated using the hardware identifier(s) of the camera device 300 and encrypted with the camera temporary shared key generated during the manufacturing process. As explained, hardware identifiers can be used to identify hardware components of the camera device 300.

The processor can read one or more hardware identifiers from the camera device 300. For example, the processor can read the hardware identifier of CPU/MCU chip 314 as a first hardware identifier, R1, and the hardware identifier of a Wi-Fi chip as a second hardware identifier, R2. The processor can continue to read any number of hardware identifiers (R3-Rn) from any peripheral hardware on the camera device, depending on the implementation of method 1200. Examples of hardware identifiers include but are not limited to a CPU serial number, a Wi-Fi serial number, storage serial number, image sensor ID, battery serial number, GPS module ID, and lens ID. The order and number of hardware identifiers read by the processor can vary depending on the camera device 300 and be set by the manufacturer 150.

In at least one embodiment, the processor generates a tuple of hardware identifiers and identification tag data field ‘c’, (R1, R2, R3 . . . Rn, c), and encrypts the tuple of hardware identifiers using the camera temporary shared key. The encrypted tuple of hardware identifiers can be saved as the manufacturing hardware header.

The manufacturing public key header can be an authentication image header that is generated during the manufacturing process and that includes the local public key generated as described above. The local public key can be stored unencrypted.

The manufacturing weights header can be an authentication image header that is generated during the manufacturing process, for example, by the verifier 130, 230 and that includes a weights file encrypted using the camera temporary shared key generated as described above. The first layer weights file can be a file that includes a random list of weights and biases and that corresponds to the first layer of the verifier weights file stored on the camera device. The random list of weights and biases can be generated using a random number generator and can be unique to each camera device 300. The random number generator can be generative neural network 700, shown in FIG. 7.

Referring briefly to FIG. 7, there is shown an example generative neural network 700 for generating authentication data. Generative neural network 700 takes an input 710 and generates an output 750. Input 710 can include a prompt and a seed. The prompt can specify conditions to guide the generation process. The seed serves as an initial value that ensures deterministic behavior, allowing for reproducibility of the output. In some embodiments, identification tag data can be used as the prompt and seed. For example, identification tag data field ‘e’ can be used as the prompt and identification tag data field ‘c’ can be used as the seed. Using these identification tag data fields as the prompt and seed can ensure a high level of entropy as they change on each read of the identification tag.

Generative neural network 700 includes input layer 720, variable layers 730, and output layer 740. Input layer 720 consists of multiple nodes designed to process input 710. The input layer passes 720 passes data to variable layers 730, which are intermediate processing layers of the neural network, such as hidden layers, where the input is transformed through learned weights and activations. These layers introduce non-linearities, allowing the network to model complex patterns. The output layer 740 generates output 750 by mapping the transformed data from the variable layers 730 into a meaningful output. The output 750 is a deterministic output of pseudo-random numbers that can be used to create the first layer weights file.

Generative neural network 700 can be designed to be on the order of a few kilobytes in size or any size that is compatible with the storage and processing limitations of the camera device.

The pseudo-random numbers generated by generative neural network 700 are used to create a random list of weights and biases. The random list of weight and biases can be used to create a first layer weights file. The first layer weights file can be encrypted with the camera temporary shared key generated as described above and stored as the manufacturing weights header.

The manufacturing tag header, manufacturing hardware header, manufacturing public key header, and manufacturing weights header can be generated during the manufacturing process and can be stored in the secure storage of the tag reader, such as secure storage 332 or secure storage 430. These four authentication image headers can later be coupled to an authenticated image, as will be described with respect to step 1260.

The processor can generate a symmetric key to be used for generating further authentication image headers. The processor can generate the symmetric key using a generative neural network, such as generative neural network 700. The generative neural network can be executed in a trusted execution environment (TEE), in a processor of the camera device 300, for example, in CPU/MCU unit 314 or in crypto engine 334. Identification tag data field ‘e’ can be used as the prompt and identification tag data field ‘c’ can be used as the seed for the generative neural network. These fields can be securely sent from the identification tag to the processor. The generative neural network can be a deterministic neural network defined by the verifier weights file stored on the camera device. The generative neural network outputs deterministic hex data that can be trimmed to the known size of the symmetric key by a slice or cut operation, thus generating the symmetric key. The symmetric key can be stored in the crypto engine of the tag reader. The symmetric key may not be accessible once it is written to crypto engine and may only be used by sending encrypted data to and receiving decrypted data from crypto engine.

The boot key header can be an authentication image header that is generated when the camera device 300 is booted. The processor of the camera device can generate a boot key pair consisting of a boot private key and a boot public key {Bprk, Bpuk}. The boot key pair {Bprk, Bpuk} can be generated using a method substantially similar to the method of generating the local key pair, as discussed above. The boot private key can be used to digitally sign images captured by the camera device 300 during the boot session. During the boot session, the boot private key can be stored only in RAM, such as RAM 322. The boot private key can be discarded upon camera device 300 power down. A new boot key pair can be generated upon each new boot of the camera device 300. The boot public key can be stored as the boot key header.

The boot hardware header can be an authentication image header that is generated when the camera device 300 is booted. The processor can generate a camera boot shared key, S_{bt}.

In some embodiments, the camera boot shared key comprises the boot private key and the verifier public key {Bprk, Vpuk}. However, in various other embodiments, the camera boot shared key combining the boot private key and the verifier public key is not directly used to encrypt a boot hardware header. Instead, in such embodiments, the boot private key and the verifier public key are used to create a derived camera boot shared key by using a HMAC (Hashed Message Authentication Code)-based Key Derivation Function (HKDF) or a custom hash function.

In various embodiments, the derived key is generated using a unique, arbitrary or random value, or a nonce (‘number used once’), where (S_{bt}=HASH (S_{bt+some random parameters})). In some embodiments, the nonce is the random hex numbers generated via the neural network random generator disclosed herein.

The use of the derived key as the camera boot shared key ensures that a different or a unique camera boot shared key is used during each session/hardware and is bound to random parameters that link to the camera firmware and the tag hardware.

The boot hardware header can be generated using a method substantially similar to the method of generating the manufacturing hardware header and include substantially similar information to the manufacturing hardware header. However, the tuple of hardware identifiers in the boot hardware header can be encrypted with the camera boot shared key instead of the camera temporary shared key. For example, the boot hardware header can be an encrypted tuple of hardware identifiers and identification tag data field ‘c’: (R1, R2, R3 . . . Rn, c).

The operation tag header can be an authentication image header that is generated when the camera device 300 is booted, and at fixed intervals during camera operation. The operation tag header can be generated using a method substantially similar to the method of generating the manufacturing tag header. However, the identification tag data can be encrypted using the symmetric key instead of the camera temporary shared key. For example, the operation tag header can include a URL such as example URL https://verifier?e=E&c=C&b=B&F=f&sno=SNO&a=A, encrypted with the symmetric key.

The image hash header can be an authentication image header that is generated for each image. An image hash can be created by processing an image to generate a unique, fixed-size string or number that represents the image content. Any hashing algorithm used for generating an image hash for an image can be used to generate the image hash. The image hash can be encrypted using the camera boot shared key and stored as the image hash header.

Optionally, the processor can generate a watermark header for each image. The watermark header can be generated using a generative neural network, such as generative neural network 700. The generative neural network can receive, through an encrypted channel, identification tag data fields ‘e’ and ‘c’. Identification tag data field ‘e’ can be used as the prompt and identification tag data field ‘c’ can be used as the seed for the generative neural network. The generative neural network can output hex data which is parsed for hex values representing pixel locations in the image. A tuple of hex values representing pseudo pixel locations, {p1, p2, p3 . . . } can be generated. The tuple of hex values can be converted to integers using a scale of 0 to the maximum width of the image. The converted tuple of hex values can be treated as the x values of pixels to be watermarked, {x1, x2, x3 . . . }.

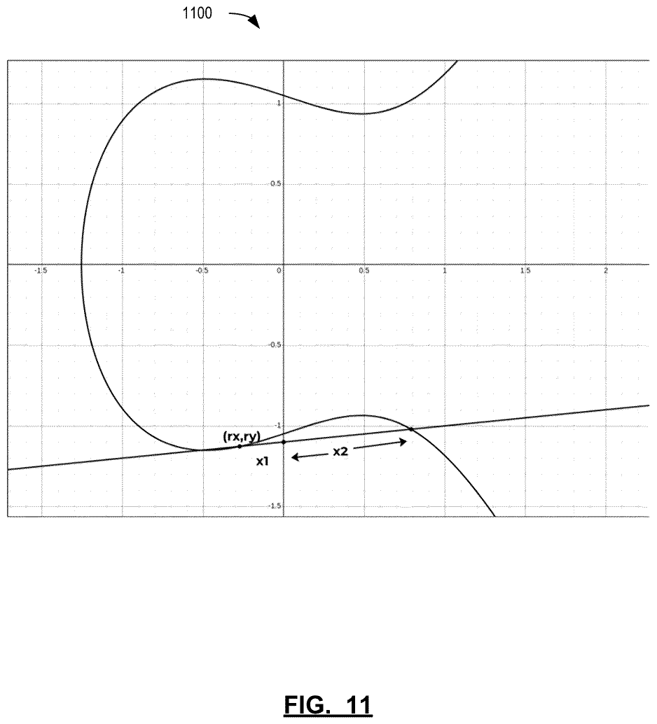

Two discrete parameters, A and B, can be obtained from the data stored in ISP chip 312. For example, A and B may be ISP constants, register values or values obtained by setting some of the internal parameters such as white balance, gamma correction, lens shading correction, and color correction matrix. Parameters A and B can be shared secrets registered by the manufacturer 150 with the verifier 130 or verifier 230 during the manufacturing process. Parameters A and B can define a secret elliptic curve, y²=x³+Ax+B, and can be constant values. The secret elliptic curve can be example elliptic curve 1100, shown in FIG. 11. At the time of photo capture, a random point, (rₓ, r_{y}), is selected on the curve, and a tangent line is calculated at this point, as shown in FIG. 11. From this tangent, integers x₁, x₂, and x₃ are chosen to generate watermark coordinates (x₁, y₁), (x₂, y₂), and (x₃, y₃) along the tangent line. The pixels at the watermark coordinates are modified according to a known watermarking algorithm implemented by manufacturer 150. The watermarking algorithm can be sent from manufacturer 150 to verifier 130 or verifier 230 as a shared secret. The verifier can store the watermarking algorithm in verifier database 140. An example algorithm for watermarking can involve setting watermarked pixel RGB values to the average value of all immediately surrounding pixels. Other techniques may involve using a known function to adjust the value of the watermarked pixel based on one more surrounding pixel values. The watermarked pixels can create a digital watermark on the image. For a video, a digital watermark can be applied to selected frames of the video.

The watermarking can be performed on the ISP chip, as shown in FIG. 10. Referring briefly to FIG. 10, there is shown an example method 1000 for watermarking an image. Method 1000 involves sending data from lens 1002 to an image processing pipeline 1010. Image processing pipeline can include a sensor with a color filter array (CFA) that outputs an unprocessed, high-resolution raw image file. Image processing pipeline can further include one or more of the steps of ISO gain/dead pixel/black level/lens shading, RGB demosaicing, noise reduction, white balance & color space transform, color manipulation, edge enhancement/contrast/brightness control, mapping to sRGB output, and encoding. The watermarking 1030 can be performed on the raw image file output by the sensor or the processed image file output at the end of image processing pipeline 1010. After watermarking, the image can be saved as an encoded file at 1040 or saved as a raw file at 1042.

The random point, (rₓ, r_{y}), and the watermarked pixels (x₁, y₁), (x₂, y₂), and (x₃, y₃) can be encrypted with camera boot shared key and saved in the watermark header. The watermark may also include a hash of parameters A and B. The hash of parameters A and B can be generated using any suitable hashing algorithm, such as SHA256. In embodiments where the image is watermarked and a watermark header is generated, the image hash header may be generated after the watermark header is generated and the image is watermarked.

At 1260, at least some of the authentication image headers are coupled to the image captured at 1210.

Referring now to FIGS. 8 and 9, there are shown two example image files with authentication image headers. As shown in FIG. 8, authentication image headers 812 can be coupled to the image by embedding them directly into the existing header 810 of image file 800. Image file 800 can be an image stored in a file format that includes headers, such as the JPEG file format. Within the header 810, there may be authentication image headers 812 and existing headers 814. Examples of existing headers 814 include the SOI (Start of Image) marker, APPn (Application-specific markers) such as APPO (JFIF) and APP1 (EXIF), DQT (Define Quantization Table), SOF (Start of Frame), DHT (Define Huffman Table), SOS (Start of Scan), and the EOI (End of Image) marker.

In FIG. 8, authentication image headers 812 are added directly into the image file's metadata structure and the authenticatable image is a single file.

Alternatively, as shown in FIG. 9, authentication image headers 912 can be stored in a separate header file 910 that is coupled to the image file 920. For example, if the image is stored in a file format that does not include headers, such as a RAW file format, authentication image headers 912 can be stored separately. Header file 910 can include authentication image headers 912 and other headers 914. The header file 910 can be a distinct file that is linked to the image file 920 that contains image data 922. The header file can be named to correspond to the image file or contain a unique identifier referencing the image.

Image data 820 and image data 922 can be pixel data that represents the visual content of the image. Example formats of image file 800 include JPEG, PNG, GIF, BMP, and HEIC. Example formats of image file 920 include RAW formats (like CR2, NEF, ARW), PBM (Portable Bitmap), PGM (Portable Graymap), and PPM (Portable Pixmap).

The authenticatable image can be written to a non-volatile storage medium such as storage module 320 for long-term storage and retrieval. Storage module 320 can be any suitable storage medium, such as flash memory or a removable SD card.

As explained, authenticatable images generated according to method 1200 can be assessed to determine their authenticity.

Referring to FIG. 13, shown therein is a schematic diagram of a process 1300 for authenticating an image. As shown, an image can be captured by camera device 610 and an authenticable image 1310 that includes the image captured by the camera device 610 and includes authentication image headers can be generated as described with reference to the method 1200 of FIG. 12.

The authenticatable image 1310 can be transferred to a computing device 1320 such as a smartphone 1320a or a desktop or laptop computer 1320b. Although computing devices 1320a and 1320 are shown, it will be understood that computing devices 1320 can be any computing device capable of uploading images to a network, such as a smartphone, a desktop computer, a laptop computer, and a tablet. The authenticatable image 1310 can be transferred to computing devices 1320 through any suitable data transfer method such as an SD card, a USB connection, Wi-Fi, or Bluetooth.

To verify an image, the computing device 1320 can transmit an image to the verifier system 1340 via network 1330. Network 1330 can be substantially similar to network 110. The verifier system 1340 can be provided by verifier 130 or verifier 230, described with reference to FIGS. 1 and 2, and may be a web-based service for verifying the authenticity of images. The verifier system 1340 can include a processor, a server and a database, such as verifier database 140. In embodiments where the verifier system 1340 is a web-based service, computing device 1320 can upload the authenticable image 1310 to the verifier system 1340.

In alternative embodiments, camera device 610 is equipped with network connectivity capabilities and can transmit an authenticatable image 1310 directly to the verifier system 1340 via network 1330.

In at least one embodiment, the computing device 1320 can facilitate image attribution of the authenticatable image 1310. For example, when the user of camera device 610 uploads an authenticatable image 1310 to network 1330, the user can include image attribution information. Image attribution can be manually added. For example, the user can manually add a photographer's name, affiliation or other identifying credentials to the authenticatable image 1310. Alternatively, image attribution information can be automatically added to authenticatable image 1310. For example, camera attribution information that is linked to the camera device can be automatically added to authenticatable image 1310. In the case of automated cameras, camera attribution information can be the name of the organization that owns the camera. Optionally any other data can be manually or automatically added to authenticated image 1310, such as usage rights, licensing terms, copyright status, and any other contextual information that the user designates for disclosure.

In at least one embodiment, the verifier system 1340 includes a camera attribution system 1350. The camera attribution system 1350 can enable the camera device 610 user or the user of the computing device 1320 to “claim” or take ownership of a camera device. The camera attribution system will now be described in an embodiment where identification tag, such as identification tag 640, is an NFC tag and tag readers are NFC tag readers. However, it will be appreciated that the camera attribution system 1350 can have other embodiments where identification tag and tag readers use different communication protocols, such as RFID or Bluetooth.

In embodiments where the identification tag, such as identification tag 640, is an NFC tag, the user can initiate the camera attribution process by tapping an NFC-enabled tag reader, such as a smartphone or custom NFC reader, against identification tag 640. The tag reader can read the data from the identification tag 640, which can redirect the user to a URL for the verifier system 1340 via network 1330. Upon accessing the URL, the verifier system 1340 can authenticate the identification tag 640 against a pre-registered manufacturing record of the camera device 610, created during the manufacturing stage. If the verifier system 1340 determines that a pre-registered manufacturing record can be found for the camera device 610, the verifier system 1340 can present the user with a login interface to establish and claim ownership of the camera device 610. For example, the user can enter identifying information and the verifier system 1340 can associate the identification information with the camera device 610. If the verifier system 1340 determines that a pre-registered manufacturing record cannot be found for the camera device 610, the verifier system 1340 can notify the user, for example, via a notification displayed on the NFC-enabled reader or the computing device 1320 that the camera device 610 cannot be claimed.

Once ownership is successfully claimed, the verifier system 1340 may record the manufacturing record and ownership claim on a blockchain, utilizing the camera attribution system 1350 to generate a digital certificate or a non-fungible token (NFT) stored in a custodial wallet which may be managed by the verifier system 1340. As part of this process, user information such as name and address may be collected to facilitate digital asset attribution. At the time of ownership creation, the verifier system 1340 can capture and store the monotonic read counter from the identification tag 640. This counter increments with each tag read and can be embedded in metadata for each photo or video generated by the camera device 610, linking these media assets to the owner. This ownership and attribution can remain active until the camera device 610 is transferred or sold, at which point a new ownership claim can be established. If the camera is declared lost or blacklisted, the verifier system 1340 can restrict further ownership or attribution functionality for the camera device 610 until its status is reinstated.

Referring now to FIG. 14, there is shown an example method 1400 for verifying the authenticity of an image by a verifier system, such as verifier system 1340. Method 1400 can be performed by a processor of the verifier system 1340.

At 1410, the verifier system 1340 retrieves a verifier private key from a server of the verifier system 1340.

At 1420, the verifier system 1340 receives an image. For example, as explained with reference to FIG. 13, a computing device such as computing device 1320 can upload an image to the verifier system 1340. The image can correspond to an authenticatable image generated according to method 1200. Once the verifier system 1340 receives the image, the verifier system 1340 can extract information from the image.

The image can include a plurality of authentication image headers and image data. If the image does not include a plurality of authentication image headers, the verifier system 1340 can terminate the process for verifying the authenticity of the image and generate an output indicating that the image is not eligible to have an authenticity verified. For example, the verifier system 1340 can cause a notification to be displayed on computing device 1320 indicating that the image is not verifiable.

At 1430, the verifier system 1340 extracts a boot public key from a boot key header. The boot key header can be the boot key header described with reference to FIG. 12. The boot public key can be stored in an unencrypted format in boot key header and can accordingly be extracted without a decryption process.

At 1440, the verifier system 1340 generates a verifier boot shared key {Vprk, Bpuk} using the verifier private key, retrieved at 1410 and the boot public key, extracted at 1430.

At 1450, the verifier system 1340 decrypts a first image hash from an image hash header using the verifier boot shared key generated at 1440. The image hash header can be the image hash header as described with reference to FIG. 12.

At 1460, the verifier system 1340 generates a second image hash from the image data. The second image hash can be generated using the same hash algorithm that was used to generate the image hash stored in the image hash header. For example, the verifier system 1340 can store in a database, a list of hash algorithms in association with manufacturers, camera devices, and/or batches of camera devices. For example, when the image is received at 1420, the verifier system 1340 can identify the manufacturer of the camera device that has captured the image and/or obtain, from the computing device 1320, information about the manufacturer, the camera device and/or the batch to which the camera device belongs and the verifier system 1340 can identify the hash algorithm used for that camera device 610.

At 1470, the verifier system 1340 verifies the authenticity of the image based on a comparison of the first image hash, decrypted at 1450 and the second image hash generated at 1460. For example, the processor can perform a direct binary comparison of the first image hash and second hash. If the first image hash and the second image hash are identical, the verifier system 1340 can determine that the image passes the hash check. Otherwise, the verifier system 1340 can determine that the image fails the image hash check and that the image is not authentic.

In some embodiments, the verifier system 1340 can notify the user, for example, by causing a notification to be displayed on computing device 1320 that the image is authentic. Alternatively, the verifier system 1340 can notify the user that the image may be authentic but further checks are required to confirm the authenticity of the image. Alternatively, the verifier system 1340 can proceed with further checks and only notify the user that the image is authentic when all checks have been completed.

When the image is determined to not be authentic, the verifier system 1340 can notify the user, for example, by causing a notification to be displayed on computing device 1320 that the image is not authentic.

The verifier system 1340 can perform further checks to verify the authenticity of the image.

In embodiments where the image to be authenticated includes a watermark, the verifier system 1340 can perform a watermark check to determine the authenticity of the image. The verifier system 1340 can use the verifier boot shared key generated at 1440 to decrypt the watermark header. The watermark header can be as described with reference to FIG. 12. The image watermark parameters can be retrieved from the decrypted watermark header. The image watermark parameters can be compared to the watermark parameters sent from manufacturer 150 to verifier 130 or verifier 230 and stored at verifier database 140. If the watermark parameters match, the verifier system 1340 can determine that the image passes the watermark check. Otherwise, the verifier system 1340 can determine that the image fails the watermark check and is not authentic.

In some embodiments, the verifier system 1340 can perform a second watermark check. The verifier system 1340 can assess the watermarked pixels from the decrypted watermark header. The verifier system 1340 can use the watermarking algorithm, retrieved from the server (e.g., verifier database 140) to check whether the values of the watermarked pixels are correct. If the values of the watermarked pixels are correct, the verifier system 1340 can determine that the image passes the watermark check. Otherwise, the verifier system 1340 can determine that the image fails the watermark check.

In some embodiments, the verifier system 1340 can notify the user, for example, by causing a notification to be displayed on computing device 1320 that the image is authentic. Alternatively, the verifier system 1340 can notify the user that the image may be authentic but further checks are required to confirm the authenticity of the image. Alternatively, the verifier system 1340 can proceed with further checks and only notify the user that the image is authentic when all checks have been completed.

When the image is determined to not be authentic, the verifier system 1340 can notify the user, for example, by causing a notification to be displayed on computing device 1320 that the image is not authentic.

In at least one embodiment, the verifier system 1340 performs a tag values check on the image. To perform the tag values check, the verifier system 1340 can extract a local public key from a manufacturing public key header. The manufacturing public key header can be the manufacturing public key header described with reference to FIG. 12. As explained with reference to FIG. 12, the manufacturing public key header can store the local public key, unencrypted. The verifier system 1340 can then generate a verifier temporary shared key {Vprk, Lpuk} using the verifier private key generated at 1410 and the local public key retrieved from the manufacturing public key header. The verifier system 1340 can use the verifier temporary shared key to decrypt first identification tag data from a manufacturing tag header. The manufacturing tag header can be the manufacturing tag header described with reference to FIG. 12.

The verifier system 1340 can determine the authenticity of the image based on a comparison of the first identification tag data with camera device status information.

Camera device status information can be retrieved by the verifier system 1340 from the verifier server. The camera device status information can include information that can be used to determine the legitimacy of the camera device 610. For example, camera device status information can include a list of blacklisted camera devices. Blacklisted camera devices can for example, be camera devices that include unauthorized firmware alterations, evidence of counterfeit hardware components, malware, that have been known to be in violation of usage policies, that have repeated failed security checks or have been used in restricted or prohibited locations. As other examples, a camera device may be added to a blacklist if it is detected to produce images that fail authentication checks, suggesting tampering or unauthorized modifications. The list of blacklisted camera devices can include the cameras' unique hardware identifiers (e.g., serial number, MAC address, or embedded digital signatures).

By comparing the first identification tag data with the camera device status information, the verifier system 1340 can identify if the camera device that has generated the image is a blacklisted camera.

For example, if the first identification tag data does not have a match on the list of blacklisted camera devices, the verifier system 1340 can determine that the image passes the tag values check and is authentic or may be authentic. Otherwise, the verifier system 1340 can determine that the image fails the tags value check.

In some embodiments, the verifier system 1340 can notify the user, for example, by causing a notification to be displayed on computing device 1320 that the image is authentic. Alternatively, the verifier system 1340 can notify the user that the image may be authentic but further checks are required to confirm the authenticity of the image. Alternatively, the verifier system 1340 can proceed with further checks and only notify the user that the image is authentic when all checks have been completed.

When the image is determined to not be authentic, the verifier system 1340 can notify the user, for example, by causing a notification to be displayed on computing device 1320 that the image is not authentic.

In at least one embodiment, if the image passes the tag values check, the verifier system 1340 performs a UUID values check.

To perform the UUID values check, the verifier system 1340 generates a verifier symmetric key as described herein. The verifier system 1340 decrypts a first layer weights file from a manufacturing weights header using the verifier temporary shared key {Vprk, Lpuk}, generated when performing the tag values check. The manufacturing weights header can be the manufacturing weights header described with reference to FIG. 12.

The verifier system 1340 then retrieves a verifier weights file from the server. The verifier weights file can be the verifier weights file stored in verifier database 140, sent from the verifier 130 or verifier 230 to the manufacturer 150, and embedded, by the manufacturer 150 in the camera firmware of the camera device, as described with reference to FIG. 1. The verifier system 1340 can store verifier weights files in association with each camera (e.g., in association with identification tag data), each camera device model or a manufacturing batch of a camera device model and retrieve the specific verifier weights file associated with the camera having captured the image.

The verifier system 1340 can extract an encrypted payload field and a checksum field, such as identification tag data fields ‘e’ and ‘c’ described above, from the first identification tag data. The verifier system 1340 can then generate a verifier symmetric key using the first layer weights file extracted from the manufacturing weights header, the verifier weights file retrieved from the verifier system 1340, the encrypted payload field, and the checksum field.

For example, the first layer weights file and the verifier weights file retrieved can be combined and loaded into a verifier generative neural network, such as generative neural network 700. The first layer weights file can update the first layer of the verifier weights file retrieved. The first layer weights file and the verifier weights file can be used to define the generative neural network weights. The verifier generative neural network can be run in a digital twin virtual environment of the camera device or any other environment that mimics the CPU architecture of the camera device so that the verifier generative neural network can provide the same deterministic output as the generative neural network on the camera device. The encrypted payload field or ‘e’ can be used as the prompt and the checksum field or ‘c’ can be used as the seed for the generative neural network. The verifier generative neural network outputs deterministic hex data that can be trimmed to the desired size of the verifier symmetric key by a slice or cut operation to generate the verifier symmetric key. If the image is authentic, the verifier symmetric key generated should match the symmetric key generated on the camera device 610.

The verifier system 1340 can use the verifier symmetric key generated to decrypt second identification tag data from an operation tag header. The operation tag header can be the operation tag header described with reference to FIG. 12.

The verifier system 1340 can determine the authenticity of the image based on a comparison of the first identification tag data and the second identification tag data. For example, both first identification tag data and second identification tag data can include a UUID. If the two UUIDs match, the verifier system 1340 can determine that the image passes the UUID values check. The UUID values check can confirm that neither the identification tag nor the tag reader have been tampered with, replaced, or reprogrammed.

In some embodiments, the verifier system 1340 can notify the user, for example, by causing a notification to be displayed on computing device 1320 that the image is authentic. Alternatively, the verifier system 1340 can notify the user that the image may be authentic but further checks are required to confirm the authenticity of the image. Alternatively, the verifier system 1340 can proceed with further checks and only notify the user that the image is authentic when all checks have been completed.

If the verifier system 1340 determines that the image fails the UUID values check, the image authenticity is not verified. The verifier system 1340 can notify the user, for example, by causing a notification to be displayed on computing device 1320 that the image is not authentic or the authenticity of the image cannot be confirmed.

In at least one embodiment, the verifier system 1340 can perform a hardware identifiers check.

To perform the hardware identifiers check, the verifier system 1340 can use the verifier temporary shared key generated during the tag values check to decrypt first hardware identifier data from a manufacturing hardware header. The manufacturing hardware header can be the manufacturing hardware header described with reference to FIG. 12. The first hardware identifier data can be a tuple of one or more hardware identifiers and identification tag data field ‘c’, (R1, R2, R3 . . . Rn, c). The verifier system 1340 can use the verifier boot shared key generated at 1440 to decrypt second hardware identifier data from a boot hardware header. The boot hardware header can be the boot hardware header described with reference to FIG. 12.

The second hardware identifier data can be in the same format as first hardware identifier data.

The verifier system 1340 can determine the authenticity of the image based on a comparison of the first hardware identifier data and the second hardware identifier data.

For example, the processor can use the camera hardware parameters to perform a one-to-one check each of the items of the tuples in first hardware identifier data and second hardware identifier data. If first hardware identifier data and second hardware identifier data match, the verifier system 1340 can determine that the image passes hardware identifiers check and can notify the user, for example, by causing a notification to be displayed on computing device 1320 that the image is authentic. Otherwise, the verifier system 1340 can determine that the image fails hardware identifiers check.

The verifier system 1340 can notify the user, for example, by causing a notification to be displayed on computing device 1320 that the image is not authentic or the authenticity of the image cannot be confirmed.

The notification generated by the verification system 1340 can include, in addition to an authentication status, a confidence score and/or a time stamp. Examples of visual representations include a text output, graphical indicators like status icons (e.g., green for verified, red for unverified) or progress bars illustrating confidence levels.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A method for generating an authenticatable image by a camera device, the camera device having an identification tag affixed thereto, the method comprising:
capturing, by the camera device, an image;
retrieving, from the identification tag, a verifier public key;
generating a plurality of encryption keys, at least one of the plurality of encryption keys being generated using the verifier public key;
generating a plurality of authentication image headers;
encrypting at least one of the plurality of authentication image headers using at least one encryption key of the plurality of encryption keys; and
coupling the plurality of authentication image headers to the image.

2. The method of claim 1, wherein generating the plurality of authentication image headers comprises generating a manufacturing tag header, wherein generating the manufacturing tag header comprises:
generating a local key pair, the local key pair comprising a local private key and a local public key;
generating a camera temporary shared key, the camera temporary shared key being based on the local private key and the verifier public key;
retrieving, from the identification tag, identification tag data, wherein the identification tag data comprises at least one of: a Universally Unique Identifier (UUID), a tap count, a checksum, a batch ID, a batch creation time, a serial number, and a tag public key; and
encrypting the identification tag data using the camera temporary shared key.

3. The method of claim 2, wherein generating the plurality of authentication image headers comprises generating a manufacturing hardware header, wherein generating the manufacturing hardware header comprises:
reading at least one hardware identifier of the camera device from a processing unit of the camera device; and
encrypting the at least one hardware identifier using the camera temporary shared key.

4. The method of claim 3, wherein generating the plurality of authentication image headers comprises generating a manufacturing public key header, the manufacturing public key header comprising the local public key.

5. The method of claim 4, wherein generating the plurality of authentication image headers comprises generating a manufacturing weights header, wherein generating the manufacturing weights header comprises:
generating a first layer weights file, the first layer weights file comprising a random list of weights and biases; and
encrypting the first layer weights file using the camera temporary shared key.

6. The method of claim 5, wherein generating the plurality of authentication image headers comprises generating a boot key header, wherein generating the boot key header comprises:
upon booting the camera device, generating a boot key pair, the boot key pair comprising a boot private key and a boot public key; and
storing the boot public key as the boot key header.

7. The method of claim 6, wherein generating the plurality of authentication image headers comprises generating a boot hardware header, wherein generating the boot hardware header comprises:
generating a camera boot shared key, the camera boot shared key being based on the boot private key and the verifier public key;
reading the at least one hardware identifier of the camera device; and
encrypting the at least one hardware identifier using the camera boot shared key.

8. The method of claim 7, wherein generating the plurality of authentication image headers comprises generating an operation tag header, wherein generating the operation tag header comprises:
generating a symmetric key, wherein generating the symmetric key comprises:
retrieving, from the identification tag data, an encrypted payload field and a checksum field;
outputting hex data from a neural network model, wherein the neural network model uses the encrypted payload field as a seed and the checksum field as a prompt;
modifying the hex data according to a requirement of the symmetric key;
upon booting, retrieving, from the identification tag, the identification tag data; and
encrypting the identification tag data using the symmetric key.

9. The method of claim 8, wherein generating the plurality of authentication image headers comprises generating an image hash header, wherein generating the image hash header comprises:
generating an image hash of the image; and
encrypting the image hash using the camera boot shared key.

10. The method of claim 9, wherein generating the plurality of authentication image headers comprises generating a watermark header, wherein generating the watermark header comprises:
generating a tuple of x-values using hex values from the hex data;
retrieving secret elliptic curve parameters;
generating a random point on an elliptic curve defined by the secret elliptic curve parameters;
generating a tangent line of the elliptic curve at the random point on the elliptic curve;
determining tangent pixels, the tangent pixels comprising the tuple of x-values and corresponding y-values to the tuple of x-values on the tangent line; and
encrypting the random point, the tangent pixels and the secret elliptic curve parameters using the camera boot shared key.

11. A system for authenticating a validated image by a camera device, the camera device having an identification tag and a tag reader affixed thereto, the system comprising:
a computing device comprising at least one processor operable to:
capture an image;
retrieve, from the identification tag, a verifier public key;
generate a plurality of encryption keys, at least one of the plurality of encryption keys being generated using the verifier public key;
generate a plurality of authentication image headers;
encrypt at least one of the plurality of authentication image headers using the plurality of encryption keys; and
couple the plurality of authentication image headers to the image.

12. The system of claim 11, wherein generating the plurality of authentication image headers comprises operating the at least one processor to generate a manufacturing tag header, and wherein generating the manufacturing tag header comprises operating the at least one processor to:
generate a local key pair, the local key pair comprising a local private key and a local public key;
generate a camera temporary shared key, the camera temporary shared key being based on the local private key and the verifier public key;
retrieve, from the identification tag, identification tag data, wherein the identification tag data comprises at least one of: a Universally Unique Identifier (UUID), a tap count, a checksum, a batch ID, a batch creation time, a serial number, and a tag public key; and
encrypt the identification tag data using the camera temporary shared key.

13. The system of claim 12, wherein generating the plurality of authentication image headers comprises operating the at least one processor to generate a manufacturing hardware header, wherein generating the manufacturing hardware header comprises operating the at least one processor to:
read at least one hardware identifier of the camera device from a processing unit of the camera device; and
encrypt the at least one hardware identifier using the camera temporary shared key.

14. The system of claim 13, wherein generating the plurality of authentication image headers comprises operating the at least one processor to generate a manufacturing public key header, the manufacturing public key header comprising the local public key.

15. The system of claim 14, wherein generating the plurality of authentication image headers comprises generating a manufacturing weights header, wherein generating the manufacturing weights header comprises operating the at least one processor to:
generate a first layer weights file, the first layer weights file comprising a random list of weights and biases; and
encrypt the first layer weights file using the camera temporary shared key.

16. The system of claim 15, wherein generating the plurality of authentication image headers comprises operating the at least one processor to generate a boot key header, wherein generating the boot key header comprises operating the at least one processor to:
upon booting the camera device, generate a boot key pair, the boot key pair comprising a boot private key and a boot public key; and
store the boot public key as the boot key header.

17. The system of claim 16, wherein generating the plurality of authentication image headers comprises operating the at least one processor to generate a boot hardware header, wherein generating the boot hardware header comprises operating the at least one processor to:
generate a camera boot shared key, the camera boot shared key being based on the boot private key and the verifier public key;
read the at least one hardware identifier of the camera device; and
encrypt the at least one hardware identifier using the camera boot shared key.

18. The system of claim 17, wherein generating the plurality of authentication image headers comprises operating the at least one processor to generate an operation tag header, wherein generating the operation tag header comprises operating the at least one processor to:
generate a symmetric key, wherein generating the symmetric key comprises operating the at least one processor to:
retrieve, from the identification tag data, an encrypted payload field and a checksum field;
output a hex data from a neural network model, wherein the neural network model uses the encrypted payload field as a seed and the checksum field as a prompt;
modify the hex data according to a requirement of the symmetric key;
upon booting, retrieve, from the identification tag, the identification tag data; and
encrypting the identification tag data using the symmetric key.

19. The system of claim 18, wherein generating the plurality of authentication image headers comprises operating the at least one processor to generate an image hash header, wherein generating the image hash header comprises operating the at least one processor to:
generate an image hash of the image; and
encrypt the image hash using the camera boot shared key.

20. The system of claim 19, wherein generating the plurality of authentication image headers comprises operating the at least one processor to generate a watermark header, wherein generating the watermark header comprises operating the at least one processor to:
generate a tuple of x-values using hex values from the hex data;
retrieve secret elliptic curve parameters;
generate a random point on an elliptic curve defined by the secret elliptic curve parameters;
generate a tangent line of the elliptic curve at the random point on the elliptic curve;
determine tangent pixels, the tangent pixels comprising the tuple of x-values and corresponding y-values to the tuple of x-values on the tangent line; and
encrypt the random point, the tangent pixels and the secret elliptic curve parameters using the camera boot shared key.

21. A method for verifying an authenticity of an image by a verifier system, the verifier system comprising a processor and a server, the method comprising operating the processor to:
retrieve, from the server, a verifier private key;
receive the image, the image comprising a plurality of authentication image headers and image data;
extract a boot public key from a boot key header;
generate a verifier boot shared key using the verifier private key and the boot public key;
decrypt a first image hash from an image hash header using the verifier boot shared key;
generate a second image hash from the image data; and
determine the authenticity of the image based on a comparison of the first image hash and the second image hash.

22. The method of claim 21, further comprising operating the processor to:
extract a local public key from a manufacturing public key header;
generate a verifier temporary shared key using the verifier private key and the local public key;
decrypt a first identification tag data from a manufacturing tag header using the verifier temporary shared key;
retrieve from the server, camera device status information, the camera device status information including information to determine a legitimacy of a camera device; and
determine the authenticity of the image based on a comparison of the first identification tag data with the camera device status information.

23. The method of claim 22, further comprising operating the processor to:
generate a verifier symmetric key, wherein generating the verifier symmetric key comprises operating the processor to:
decrypt a first layer weights file from a manufacturing weights header using the verifier temporary shared key, the first layer weights file comprising a random list of weights and biases;
retrieve from the server, a verifier weights file;
extract an encrypted payload field and a checksum field from the first identification tag data; and
generate the verifier symmetric key using the first layer weights file, the verifier weights file, the encrypted payload field and the checksum field;
decrypt second identification tag data from an operation tag header using the verifier symmetric key; and
determine the authenticity of the image based on a comparison of the first identification tag data and the second identification tag data.

24. The method of claim 23, further comprising operating the processor to:
decrypt first hardware identifier data from a manufacturing hardware header using the verifier temporary shared key;
decrypt second hardware identifier data from a boot hardware header using the verifier boot shared key; and
determine the authenticity of the image based on a comparison of the first hardware identifier data and the second hardware identifier data.

25. The method of claim 24, further comprising operating the processor to:
decrypt first secret elliptic curve parameters and tangent pixels from a watermark header using the verifier boot shared key;
retrieve from the server, second secret elliptic curve parameters; and
determine the authenticity of the image based on at least one of a comparison of the first secret elliptic curve parameters and the second secret elliptic curve parameters and a check of the tangent pixels of the image.

26. A verifier system for verifying an authenticity of an image, the verifier system comprising:
a server configured to store a verifier private key;
a processor operable to:
retrieve, from the server, the verifier private key;
receive the image, the image comprising a plurality of authentication image headers and image data;
extract a boot public key from a boot key header;
generate a verifier boot shared key using the verifier private key and the boot public key;
decrypt a first image hash from an image hash header using the verifier boot shared key;
generate a second image hash from the image data; and
determine the authenticity of the image based on a comparison of the first image hash and the second image hash.

27. The verifier system of claim 26, wherein the processor is further operable to:
extract a local public key from a manufacturing public key header;
generate a verifier temporary shared key using the verifier private key and the local public key;
decrypt first identification tag data from a manufacturing tag header using the verifier temporary shared key;
retrieve, from the server, camera device status information, the camera device status information including information to determine a legitimacy of a camera device; and
determine, the authenticity of the image based on a comparison of the first identification tag data with the camera device status information.

28. The verifier system of claim 27, wherein the processor is further operable to:
generate a verifier symmetric key, wherein generating the verifier symmetric key comprises operating the processor to:
decrypt, a first layer weights file from a manufacturing weights header using the verifier temporary shared key, the first layer weights file comprising a random list of weights and biases;
retrieve, from the server, a verifier weights file;
extract, an encrypted payload field and a checksum field from the first identification tag data; and
generate the verifier symmetric key using the first layer weights file, the verifier weights file, the encrypted payload field and the checksum field;
decrypt second identification tag data from an operation tag header using the verifier symmetric key; and
determine the authenticity of the image based on a comparison of the first identification tag data and the second identification tag data.

29. The verifier system of claim 28, wherein the processor is further operable to:
decrypt first hardware identifier data from a manufacturing hardware header using the verifier temporary shared key;
decrypt second hardware identifier data from a boot hardware header using the verifier boot shared key; and
determine the authenticity of the image based on a comparison of the first hardware identifier data and the second hardware identifier data.

30. The verifier system of claim 29, wherein the processor is further operable to:
decrypt first secret elliptic curve parameters and tangent pixels from a watermark header using the verifier boot shared key;
retrieve, from the server, second secret elliptic curve parameters; and
determine the authenticity of the image based on at least one of a comparison of the first secret elliptic curve parameters and the second secret elliptic curve parameters and a check of the tangent pixels of the image.
